(19) United States
(12) Patent Application Publication
(10) Pub. No.: US 2026/0149662 A1
(43) Pub. Date: May 28, 2026

(54) Dynamic Power Regulation in Network Devices

(71) Applicant: Cisco Technology, Inc., San Jose, CA (US)

(72) Inventors: Yi Tang, San Jose, CA (US); Chih-Tsung Huang, San Jose, CA (US)

(21) Appl. No.: 18/957,809

(22) Filed: Nov. 24, 2024

(51) Int. Cl. H04L 47/12; H04L 43/08; H04L 47/30

(52) U.S. Cl. CPC H04L 47/12; H04L 43/08; H04L 47/30

(57) ABSTRACT

Existing power consumption management strategies respond to power usage spikes only after they occur, increasing the risk of circuit breaker trips and unexpected shutdowns. To address this, devices, systems, methods, and processes for facilitating dynamic power regulation are described herein. A network device in a network monitors one or more power usage metrics associated with the network device and compares the power usage metrics with a threshold value. Based on determining that the power usage metrics are greater or equal to the threshold value, the network device detects a power surge event. The network device mimics, based on the detection of the power surge event, a congestion event causing a reduction in an initial data throughput of the network device to a diminished data throughput that decreases power consumption in the network device. Thus, making the network device to recover from the power surge event.

The present disclosure relates to communication networks. More particularly, the present disclosure relates to dynamic power regulation in network devices.

### BACKGROUND

A modern data center integrates artificial intelligence (AI) graphical processing units (GPUs) to accelerate machine learning, deep learning, and high-performance workloads. It operates under strict power and cooling limits, relying on advanced networking, storage, and traffic management systems to optimize performance and energy efficiency. These data centers are increasingly under pressure to manage their energy consumption as they integrate AI-driven GPU computing and other high-performance workloads. The data centers mostly operate within fixed peak power limits, which are determined by the design of electrical, cooling, and hardware infrastructure. However, the rapid adoption of power-intensive AI technologies has stretched the capabilities of these existing infrastructures. Network devices (such as switches, routers, processors, firewalls, or the like) often process fluctuating workloads, leading to unpredictable power consumption. Traditional network traffic management systems tend to prioritize data throughput and congestion control, with limited emphasis on real-time power usage metrics, which can result in challenges when balancing power usage with performance.

Traditional power management systems in the data centers respond to power usage spikes only after they occur, increasing the risk of circuit breaker trips and unexpected shutdowns. These systems rely on static thresholds and lack the ability to dynamically adjust power consumption in real-time, especially when managing workloads driven by high-performance GPUs. This limited adaptability often results in forced shutdowns of switches or GPU workloads to prevent overloading, resulting in operational disruptions operations and downtime. External pressures, such as energy-saving mandates, further complicate the challenge, underscoring the limitation of existing power regulation solutions. These gaps have intensified the demand for accurate “not-to exceed” (NTE) power guarantees and innovative, adaptive power management strategies to maintain uninterrupted service continuity and increasing GPU-driven workloads.

### SUMMARY OF THE DISCLOSURE

Systems and methods for facilitating dynamic power regulation in network devices in accordance with embodiments of the disclosure are described herein.

In many embodiments, a network device comprises a network controller, a processor and a memory. The network controller is configured to provide access to a network. The memory is coupled to the processor and comprises a power management logic that is configured to detect a power surge event associated with the network device. The power management logic is further configured to mimic, based on the detection of the power surge event, a congestion event for the network device that reduces an initial data throughput of the network device at a time of the power surge event to a diminished data throughput.

In a variety of embodiments, a power consumption of the network device decreases based on the reduction of the initial data throughput to the diminished data throughput.

In a number of embodiments, based on the decrease in the power consumption, the network device recovers from the power surge event.

In further embodiments, the power management logic is further configured to regulate power consumption in the network device based on the mimicked congestion event.

In several embodiments, to detect the power surge event, the power management logic is further configured to monitor one or more power usage metrics associated with the network device.

In additional embodiments, at least one power usage metric of the one or more power usage metrics corresponds to a power consumption by the network device.

In more embodiments, the power management logic is further configured to compare the at least one power usage metric with a threshold value associated with the network device and determine, based on a result of the comparison, that the at least one power usage metric is greater than or equal to the threshold value. The power surge event is detected in response to determining that the at least one power usage metric is greater than or equal to the threshold value.

In numerous embodiments, the one or more power usage metrics comprise one or more of an average data byte size handled by the network device or an instantaneous total bandwidth utilized by the network device.

In various embodiments, the power management logic is further configured to monitor the one or more power usage metrics in real time or near real time.

In one or more embodiments, the power management logic is further configured to monitor the one or more power usage metrics at a plurality of periodic time intervals.

In yet more embodiments, the power management logic is further configured to mimic the congestion event based on a congestion management protocol or a flow control protocol enabled on the network device.

In still more embodiments, the network device is associated with one or more data queues, and to mimic the congestion event, the power management logic is further configured to reduce a congestion threshold associated with at least one data queue of the one or more data queues from an initial value to a modified value.

In still yet more embodiments, the power management logic is further configured to obtain the modified value based on a current queue depth of the at least one data queue at a time of the power surge event.

In many further embodiments, the modified value is less than the current queue depth of the at least one data queue.

In several more embodiments, a control device comprises a processor, a network interface controller configured to provide access to a network, and a memory communicatively coupled to the processor. The memory comprises power management logic that is configured to detect a power surge event associated with a network device of the one or more network devices. The power management logic is further configured to control the network device to mimic a congestion event, and the mimicked congestion event reduces an initial data throughput of the network device at a time of the power surge event to a diminished data throughput.

In many additional embodiments, the power management logic is further configured to receive one or more power usage metrics associated with the network device.

In many more embodiments, the power management logic is further configured to compare the at least one power usage metric with a threshold value associated with the network device and determine, based on a result of the comparison, that the at least one power usage metric is greater than or equal to the threshold value. The power surge event is detected in response to determining that the at least one power usage metric is greater than or equal to the threshold value.

In several additional embodiments, the one or more power usage metrics are received from the network device in real time or near real time.

In numerous additional embodiments, the one or more power usage metrics are received from the network device at a plurality of periodic time intervals.

In various additional embodiments, a method comprises detecting a power surge event associated with a network device and mimicking, based on the detection of the power surge event, a congestion event for the network device that causes a reduction in a data throughput of the network device.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of an example architecture for a network fabric in accordance with various embodiments of the disclosure;

FIG. 2 is a schematic block diagram of an example network employing dynamic power regulation in network devices in accordance with various embodiments of the disclosure;

FIG. 3 is a conceptual flow diagram illustrating dynamic power regulation in a network device in accordance with various embodiments of the disclosure;

FIG. 4 is a diagram depicting various subsets of artificial intelligence in accordance with various embodiments of the disclosure.

FIG. 5 illustrates different methods of machine-based learning in accordance with various embodiments of the disclosure;

FIG. 6 is a machine learning lifecycle in accordance with various embodiments of the disclosure;

FIG. 7 is an exemplary neural network in accordance with various embodiments of the disclosure;

FIG. 8 is a flowchart depicting a process for regulating power consumption in a network device in accordance with various embodiments of the disclosure;

FIG. 9 is a flowchart depicting a process for dynamic regulation of power consumption in a network device in accordance with various embodiments of the disclosure;

FIG. 10 is a flowchart showing a process for remote regulation of power consumption of a network device in accordance with various embodiments of the disclosure;

FIG. 11 is a flowchart showing a process for pre-emptive regulation of power consumption of a network device in accordance with various embodiments of the disclosure; and

FIG. 12 is a conceptual block diagram of a device suitable for configuration with a power management logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein to facilitate dynamic power regulation in network devices, for example, in a data center. Current data centers incorporate high-performance graphical processing units (GPUs) to enhance Artificial Intelligence (AI), Machine Learning (ML), deep learning, and other high-performance computing tasks. These data centers function within stringent power and cooling constraints, leveraging advanced networking, storage, and traffic management technologies to improve both performance and energy efficiency. As AI-driven GPU computing and other resource-intensive workloads become more prevalent, data centers face increasing pressure to monitor and manage their energy consumption. Operating within fixed peak power limits established during the design phase of their electrical, cooling, and hardware systems, the data centers are now challenged by the rapid rise of power-intensive AI technologies. Network devices (such as switches, routers, processors, firewalls, or the like) often process varying workloads, leading to unpredictable power consumption. Further, conventional network traffic management approaches primarily emphasize data throughput and congestion control without factoring in real-time power consumption metrics, making it challenging to balance power usage with performance.

Moreover, traditional power management systems react to power spikes only after they happen, heightening the risk of circuit breaker trips and unexpected system shutdowns. These systems often rely on static thresholds, lacking the capability for real-time power consumption adjustments, especially when dealing with AI-accelerated workloads. Further, existing network congestion management protocols, such as pause frames and Explicit Congestion Notification (ECN), are primarily designed to control data flow and may not account for power constraints, potentially exposing network devices to excessive energy use during peak periods. As a result, the primary option to prevent power overloads frequently involves shutting down the network devices, causing operational disruptions and resulting in downtime. In addition, external pressures, such as energy conservation regulations, complicate data center operations. The absence of dynamic, power-aware control mechanisms may hinder the ability to maintain continuous service delivery.

Thus, the present disclosure provides a solution for dynamic power regulation through adaptive power management strategies, ensuring uninterrupted operations. A network device (e.g., a leaf switch, a spine switch, a router, a firewall, or the like) may be an integral component of a data center and may be communicatively coupled to a plurality of devices that participate in data packet transmission in a network. The plurality of devices may include end-point devices (for example, laptops, smartphones, printers, IoT devices, desktop computers, servers or the like) and other network devices. The network device may receive a series of data packets and may analyze a destination address (e.g., media access control “MAC” address) of each data packet. Based on the destination address, the network device may forward the data packets to a specific port associated with the destination address, ensuring efficient data transmission within the network. During switching the data packets from source devices to destination devices, the network device may consume power to support the handling, processing, and transmission of the data packets. The higher the data transmission rate, the more power the network device consumes. If the data transmission rate is high enough to cause power consumption in the network device to exceed a maximum power usage limit allocated to the network device, the network device may malfunction or may be shut down. Thus, leading to potential disruption in data transmission services. However, the network device of the present disclosure is equipped with a power management logic, which can be either integrated or remotely connected, to implement a power regulation strategy that allows the network device to operate within safe power usage limits, for example, below the maximum power usage limit allocated to the network device.

In many embodiments, the network device may include a network controller configured to provide access to the network. The network device may further include a processor and a memory communicatively coupled to the processor. In some embodiments, the memory may include the power management logic. In certain embodiments, the power management logic can be embodied as a standalone component within the network device. The power management logic may execute one or more adaptive power management strategies for dynamic power regulation.

In a number of embodiments, the network device may be configured to monitor one or more power usage metrics associated with power consumed by the network device. The one or more power usage metrics can be monitored in real time or near real time. Further, the one or more power usage metrics can be monitored at a plurality of periodic time intervals. At least one power usage metric of the one or more power usage metrics may correspond to a real-time or near real time power consumption by the network device. The one or more power usage metrics may further include one or more of an average data byte size handled by the network device, an instantaneous total bandwidth utilized by the network device, or the like. In more embodiments, the network device may be configured to compare the at least one power usage metric (for example, the power consumption) with a threshold value. The threshold value may be indicative of a maximum power usage limit of the network device. Based on a result of the comparison, the network device may determine whether the at least one power usage metric (for example, the power consumption) is greater than or equal to the threshold value. In response to the determination that the at least one power usage metric (for example, the power consumption) is greater than or equal to the threshold value, the network device may be configured to detect a power surge event. “Power surge event” may refer to an event where the real-time or near real time power consumption exceeds or is equal to the maximum power usage limit of the network device.

Based on the detection of the power surge event, the network device may be configured to mimic a congestion event that reduces an initial data throughput of the network device at a time of the power surge event to a diminished data throughput. In other words, the network device may mimic (or simulate) one or more conditions that indicate occurrence of a congestion event. Upon occurrence of a congestion event, the network device may be configured to activate a congestion management protocol or a flow control protocol to reduce data throughput of the network device. Thus, by mimicking the congestion event, the network device can activate the congestion control or the flow control protocol, effectively reducing the data throughput. As changes in data throughput correlate to power consumption of the network device, reduction in the initial data throughput of the network device to the diminished data throughput results in reduction in the power consumption of the network device. For example, based on the reduction of the initial data throughput to the diminished data throughput, the real-time or near real time power consumption of the network device may decrease and become less than the maximum power usage limit of the network device. As a result, the network device may recover from the power surge event. In this way, the power consumption in the network device may be regulated based on the mimicked congestion event.

In various embodiments, the network device may be associated with one or more data queues. “Data queue” may refer to a temporary storage in the network device that holds data packets awaiting processing or forwarding for orderly handling and data transmission. Each data queue may be configured with a congestion threshold or a queue fill level threshold, which when exceeded may result in occurrence of a congestion event. To mimic the congestion event, the network device may be configured to determine a current queue depth of at least one data queue of the one or more data queues. “Queue depth” may refer to a number of data packets or frames currently being held in a data queue. The network device may be further configured to reduce the congestion threshold associated with the at least one data queue from an initial value to a modified value, where the modified value may be determined based on the current queue depth of the at least one data queue. For example, the initial value of the congestion threshold may be greater than the current queue depth of the at least one data queue, and the modified value may be less than the current queue depth of the at least one data queue. Thus, by forcing the congestion threshold of the at least one data queue to become less than the current queue depth, the network device mimics the congestion event. Because of the mimicked congestion event, the congestion management protocol (e.g., congestion notification, Explicit Congestion Notification “ECN” or the like) or the flow control protocol enabled on the network device may be activated, resulting in data throughput reduction and in turn power consumption reduction. Once the network device recovers from the power surge event, the congestion threshold of the at least one data queue may be restored to the initial value.

In several embodiments, instead of adopting a reactive approach, the network device may implement a pre-emptive solution for dynamic power regulation. For example, the network device may predict a power surge event for a future time instance based on the monitored one or more power usage metrics. Based on the predicted power surge event, the network device may mimic a congestion event at a current time instance. Due to the mimicked congestion event, the network device may activate a congestion management protocol or a flow control protocol and reduce the data throughput of the network device, which in turn may reduce the power consumption of the network device at the current time instance. Thus, the power surge event may be prevented from occurring based on the pre-emptive solution for dynamic power regulation.

In more embodiments, the power management logic may be external to the network device. For example, the power management logic may be implemented in a remote standalone control device (such as a power management server) communicatively coupled to a plurality of network devices in the network. The control device may be configured to receive, for example, in real time or near real time, one or more power usage metrics associated with a network device of the plurality of network devices. The control device may be further configured to compare at least one power usage metric of the one or more power usage metrics with a threshold value associated with the network device and determine, based on a result of the comparison, that the at least one power usage metric is greater than or equal to the threshold value. In response to determining that the at least one power usage metric is greater than or equal to the threshold value, the control device may detect a power surge event. In yet more embodiments, the control device may be configured to control the network device to mimic a congestion event. The mimicked congestion event may reduce an initial data throughput of the network device at a time of the power surge event to a diminished data throughput. With the diminished throughput, the power consumption of the network device decreases, and based on the decrease in the power consumption, the network device may recover from the power surge event. In this way, the control device may be configured to regulate power consumption in the network device based on the mimicked congestion event.

The dynamic power regulation in network devices may offer several advantages that enhance operational efficiency and reliability. For example, regulating power usage by controlling real-time or near real-time data throughput results in energy consumption optimization. This dynamic approach may enable network devices to maintain high performance within safe power limits, minimizing the risk of overloads, circuit breaker trips, and unexpected shutdowns. The dynamic power regulation may also adapt to fluctuating workloads, promoting efficient resource use while supporting sustainable practices in line with energy-saving regulations. In addition, the predictive energy-based network operations may optimize network performance and efficiency by actively managing energy consumption across network devices. This proactive management may reduce the risk of energy-based denial of service (DoS) attacks, safeguarding network resources from malicious attempts to exploit energy usage for disruption.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit. Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data. Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

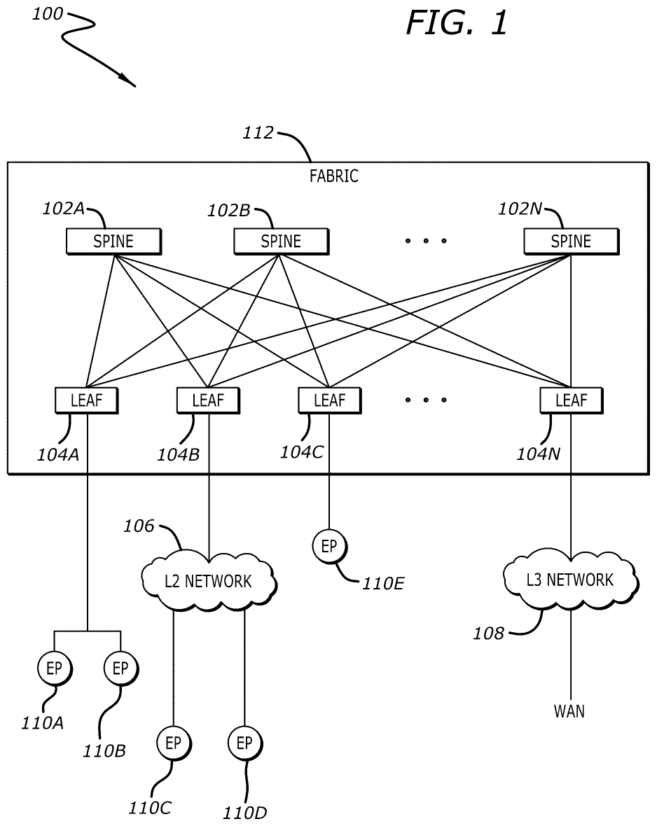

Referring to FIG. 1, a schematic block diagram of an example architecture 100 for a network fabric 112 is shown in accordance with various embodiments of the disclosure. The network fabric 112 can include spine switches 102A-102N (collectively “102”) connected to leaf switches 104A-104N (collectively “104”) in the network fabric 112. As those skilled in the art will recognize, networking fabric can refer to a high-speed, high-bandwidth interconnect system that enables multiple devices to communicate with each other efficiently and reliably. It is a network topology that is designed to provide a flexible and scalable infrastructure for data center, cloud environments, and other network elements. In many other embodiments, the network fabric 112 may correspond to a data center.

Various embodiments described herein can include a leaf-spine architecture comprising a plurality of spine switches and leaf switches. Spine switches 102 can be L3 switches in the network fabric 112. An L3 switch, or Layer 3 switch, is a networking device that operates at a network layer (Layer 3) of Open Systems Interconnection (OSI) model. However, in some cases, the spine switches 102 can also, or otherwise, perform L2 functionalities. Further, the spine switches 102 can support various capabilities, such as, but not limited to, 40 or 10 Gbps Ethernet speeds. To this end, the spine switches 102 can be configured with one or more 40 Gigabit Ethernet ports. In certain embodiments, each port can also be split to support other speeds. For example, a 40 Gigabit Ethernet port can be split into four 10 Gigabit Ethernet ports, although a variety of other combinations are available.

In many embodiments, one or more of the spine switches 102 can be configured to host a proxy function that performs a lookup of an endpoint address identifier to locator mapping in a mapping database on behalf of the leaf switches 104 that do not have such mapping. The proxy function can do this by parsing through the packet to the encapsulated tenant packet to get to the destination locator address of the tenant. The spine switches 102 can then perform a lookup of their local mapping database to determine the correct locator address of the packet and forward the packet to the locator address without changing certain fields in the header of the packet.

In various embodiments, when a data packet is received at a spine switch 1021, wherein subscript “i” indicates that this operation may occur at any spine switch 102A to 102N, the spine switch 102, can first check if the destination locator address is a proxy address. If so, the spine switch 102, can perform the proxy function as previously mentioned. If not, the spine switch 102, can look up the locator in its forwarding table and forward the packet accordingly.

In a number of embodiments, one or more spine switches 102 can connect to one or more leaf switches 104 within the network fabric 112. The leaf switches 104 can include access ports (or non-fabric ports) and fabric ports. Fabric ports can provide uplinks to the spine switches 102, while access ports can provide connectivity for devices, hosts, endpoints, VMs, or external networks to the network fabric 112.

In more embodiments, the leaf switches 104 can reside at the edge of the network fabric 112, and can thus represent the physical network edge. In some cases, the leaf switches 104 can be top-of-rack (“ToR”) switches configured according to a ToR architecture. In other cases, the leaf switches 104 can be aggregation switches in any particular topology, such as end-of-row (EoR) or middle-of-row (MoR) topologies. The leaf switches 104 can also represent aggregation switches, for example.

In additional embodiments, the leaf switches 104 can be responsible for routing and/or bridging various packets and applying network policies. In some cases, a leaf switch can perform one or more additional functions, such as implementing a mapping cache, sending packets to the proxy function when there is a miss in the cache, encapsulate packets, enforce ingress or egress policies, etc. Moreover, the leaf switches 104 can contain virtual switching functionalities, such as a virtual tunnel endpoint (VTEP) function. To this end, leaf switches 104 can connect the network fabric 112 to an overlay network.

In further embodiments, network connectivity in the network fabric 112 can flow through the leaf switches 104. Here, the leaf switches 104 can provide servers, resources, endpoints, external networks, or VMs access to the network fabric 112, and can connect the leaf switches 104 to each other. In some cases, the leaf switches 104 can connect endpoint groups to the network fabric 112 and/or any external networks. Each endpoint group can connect to the network fabric 112 via one of the leaf switches 104, for example.

Endpoints 110A-110E (collectively “110”, shown as “EP”) can connect to the network fabric 112 via the leaf switches 104. For example, endpoints 110A and 110B can connect directly to a leaf switch 104A, which can connect the endpoints 110A and 110B to the network fabric 112 and/or any other one of the leaf switches 104. Similarly, an endpoint 110E can connect directly to a leaf switch 104C, which can connect the endpoint 110E to the network fabric 112 and/or any other of the leaf switches 104. On the other hand, endpoints 110C and 110D can connect to a leaf switch 104B via an L2 network 106. Similarly, the wide area network (WAN) can connect to the leaf switches 104C or 104N via L3 network 108.

In a number of embodiments, the endpoints 110 can include any communication device, such as a computer, a server, a switch, a router, graphical processing unit (GPU), etc. In some cases, the endpoints 110 can include a server, hypervisor, or switch configured with a VTEP functionality which connects an overlay network, with the network fabric 112. For example, in some cases, the endpoints 110 can represent one or more of the VTEPs. Here, the VTEPs can connect to the network fabric 112 via the leaf switches 104. The overlay network can host physical devices, such as servers, applications, endpoint groups, virtual segments, virtual workloads, etc. In addition, the endpoints 110 can host virtual workload(s), clusters, and applications or services, which can connect with the network fabric 112 or any other device or network, including an external network. For example, one or more endpoints 110 can host, or connect to, a cluster of load balancers or an endpoint group of various applications.

In many embodiments, data packets in the network fabric 112 may flow between the leaf switches 104 and the spine switches 102, ensuring high throughput and low latency. However, the rapid transfer of large artificial intelligence (AI) workloads within the network fabric 112 can cause power surges in network devices, e.g., the leaf switches 104 and the spine switches 102. The endpoints 110, such as servers, AI GPUs, or storage devices, may transmit and receive data packets via the network fabric 112. As multiple data streams converge in the network fabric 112, one or more queues associated with the spine switches 102 or the leaf switches 104 may fill, increasing switch utilization leading to surge in power. The power surge may occur from dynamic workloads, causing increased transistor switching and heat dissipation, leading to higher power draw from both networking devices and cooling systems.

In a variety of embodiments, the leaf switches 104 and the spine switches 102 may be coupled to a power management controller or may have integrated power management controller. The power management controller may facilitate dynamic power regulation in network devices such as the leaf switches 104 and the spine switches 102. In a number of embodiments, the power management controller may be configured to detect a power surge event associated with a network device (e.g., any of the leaf switches 104 or spine switches 102). The power management controller may be further configured to mimic, based on the detection of the power surge event, a congestion event for the network device that reduces an initial data throughput of the network device at a time of the power surge event to a diminished data throughput. Reduction in the data throughput may reduce queue buildup in the network device, and as a result, a power consumption of network device may decrease and the network device may recover from the power surge event. In other words, the power management controller may leverage one or more congestion management protocols or flow control protocols enabled on the network device to dynamically regulate the power consumption of the network device. Thus, maintaining the operations of the network device below a maximum power usage limit allocated to the network device.

Although a specific embodiment for an architecture 100 is described above with respect to FIG. 1, any of a variety of systems and/or processes may be utilized in accordance with embodiments of the disclosure. For example, the architecture 100 could comprise any variety of endpoints, spine switches, and/or leaf switches. The elements depicted in FIG. 1 may also be interchangeable with other elements of FIGS. 1 and 3-12 as required to realize a particularly desired embodiment. More details about an overlay network are described in more detail below.

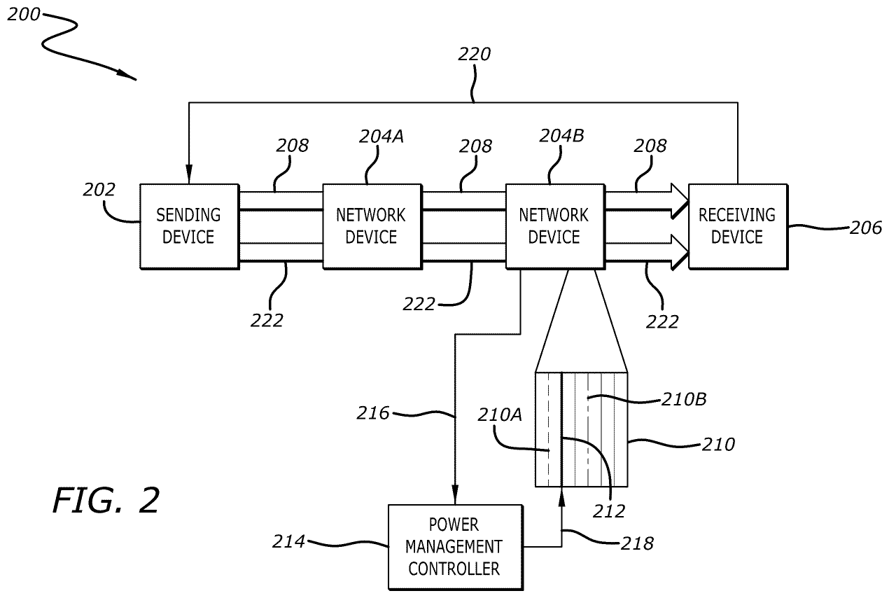

Referring to FIG. 2, a schematic block diagram of an example network 200 employing dynamic power regulation in network devices in accordance with various embodiments of the disclosure is shown. The network 200 can refer to a high-speed, high-bandwidth interconnect system that enables multiple network devices to communicate with each other efficiently and reliably. The network 200 may conform to a network topology defined to provide a dynamic power regulation for data center, cloud environments, or other network environments. The network 200 may correspond to a wireless or wired network or a combination of both facilitating dynamic power regulation in the network 200. Examples of various network protocols utilized by the network 200 may include Traditional Ethernet, Scheduled Fabric Ethernet, Remote Direct Memory Access over Ethernet (RDMA over Ethernet), Fiber Channel over Ethernet (FCOE), InfiniBand, Ultra Ethernet, NVLink, UALink, Fiber Channel, Internet Small Computer Systems Interface (iSCSI), or the like.

In many embodiments, the network 200 may include a sending device 202 communicatively coupled to a receiving device 206 via one or more network devices, for example, network devices 204A, 204B. In many embodiments, the sending device 202 and the receiving device 206 may be endpoints described in FIG. 1 and may include servers, GPUs, AI GPUs, or the like. The sending device 202 may be configured to execute a data transfer process by transmitting data packets to the receiving device 206 via the network devices 204A, 204B. In other words, the sending device 202 may be a source of the data packets and the receiving device 206 may be a destination to which the data packets are to be sent.

In various embodiments, the network devices 204A, 204B may include, for example, leaf switches, spine switches, or a combination thereof. For the sake of brevity and in a non-limiting example, the network 200 is shown to include one sending device 202, two network devices 204A, 204B, and one receiving device 206. However, in an actual implementation, the network 200 may include any variety of endpoints, spine switches, and/or leaf switches in any number of configurations.

In more embodiments, the sending device 202 may transmit a traffic flow 208, including a plurality of data packets, at an initial data throughput to the receiving device 206 via the network devices 204A, 204B. “Data throughput” may refer to a rate at which data packets are transmitted through a network over a specific period. In an example, data throughput may be measured in bits per second (bps) or bytes per second (Bps).

In many more embodiments, each of the network devices 204A, 204B may include one or more data queues. For example, a data queue 210 in the network device 204B is shown in FIG. 2. “Data queue” may refer to a buffer or a data storage that can temporarily store incoming or outgoing data packets before they are processed or forwarded. Since network devices may not always handle data packets instantly, data queues may be utilized to manage traffic by queueing data packets in an order to prevent packet loss. The network devices 204A, 204B may utilize different types of data queues (e.g., priority data queues or weighted fair data queues) to ensure that certain packets, like those for real-time applications, get processed faster than others. Each data queue may be configured with an initial congestion threshold that may be indicative of a maximum buffer capacity the data queue can store before the data queue becomes full. For example, the data queue 210 may be configured with an initial value 210A for the congestion threshold. In a scenario, if incoming data packets arrive faster than the network devices 204A, 204B can process, the one or more data queues may fill up, and if a congestion threshold of any data queue is breached or exceeded, a congestion event may occur. In the example shown in FIG. 2, a current queue depth 212 of the data queue 210 is shown to be below the initial value 210A of the congestion threshold. In some embodiments, “queue depth” may refer to a number of data packets or frames currently being held in a data queue. In certain embodiments, “queue depth” may refer to a current buffer capacity of a data queue.

In a variety of embodiments, each of the network devices 204A, 204B may have a congestion management protocol or a flow control protocol enabled to recover from congestion events. Examples of the congestion management protocol and the flow control protocol may include, but are not limited to, Explicit Congestion Notification “ECN”, Congestion Notification (IEEE 802.1Q), Adaptive Queue Management, Random Early Detection, priority-based flow control (IEEE 802.1Qbb), employing pause frames (IEEE 802.3x), or the like. If a congestion event occurs in any of the network devices 204A, 204B, the congestion management protocol or the flow control protocol enabled on the network devices 204A, 204B may be activated or triggered to recover from the congestion event. For example, the congestion management protocol or the flow control protocol when activated may attempt to reduce data transmission rates (e.g., data throughput). The reduction in the data throughput rate may clear the congested data queues, allowing the network devices 204A, 204B to recover from the congestion event without experiencing packet loss. Further, congestion data analysis for activating the congestion management protocol or the flow control protocol can be performed through sampling, filtering, grouping, classification, or continuous techniques.

In additional embodiments, each of the network devices 204A, 204B may include a processor and a memory communicatively coupled to the processor. The memory may include a power management controller 214 (e.g., a power management logic). In one or more embodiments, the power management controller 214 may include suitable logic, circuitry, and interfaces that are configured to dynamically regulate power usage in corresponding network devices 204A, 204B. Examples of the processor may include, but are not limited to, Application-Specific Integrated Circuit (ASIC) processors, Complex Instruction Set Computing (CISC) processors, Central Processing Units (CPUs), Explicitly Parallel Instruction Computing (EPIC) processors, Very Long Instruction Word (VLIW) processors, or other processors or circuits. The memory may include suitable logic, circuitry, and interfaces that are configured to store a machine code or the instructions executable by the processor. The memory may correspond to Random Access Memories (RAMs), Read Only Memories (ROMs), Electrically Erasable Programmable Read-Only Memories (EEPROMs), Hard Disk Drives (HDDs), Solid-State Drives (SSDs), or Secure Digital (SD) cards. In many additional embodiments, the power management controller 214 may embodied as a standalone hardware controller within each of the network devices 204A, 204B. In such embodiments, the power management controller 214 may be implemented as an ASIC processor, a CISC processor, a CPU, an EPIC processor, a VLIW processor, or other processors or circuits.

In further embodiments, the network devices 204A, 204B may require adequate processing power and energy to handle, transmit, and manage the traffic flow 208 and also to maintain a specific data throughput (e.g., the initial data throughput). Power consumption by the network devices 204A, 204B may be subject to variations and influenced by multiple factors, both static and dynamic, including but not limited to traffic rate, traffic pattern, atmospheric pressure, voltage, temperature, or the like. Higher data throughput demands more power.

In further additional embodiments, the network devices 204A, 204B may be configured with a maximum peak power setting (also referred to as a threshold value). For example, the maximum peak power setting, defining the maximum power usage limit of the network devices 204A, 204B, may be a configurable parameter. In one or more embodiments, the configuration of the maximum peak power can be achieved through user-defined settings, statically programmed values, or dynamically adjustable controls. Dynamic adjustments can be based on a table lookup or user-defined functions that account for variables such as traffic load, power efficiency, power factor, ambient temperature, humidity, protocol standards, or the like. For example, a table lookup may dynamically adjust power usage limit based on the current traffic load. During peak traffic hours, the power usage limit may be increased to support higher throughput, while the power usage limit may be reduced during low-traffic periods. Similarly, a user-defined function can adjust power usage limit based on power efficiency metrics, where a lower power usage limit may be set when power efficiency drops below a defined target. In further embodiments, the setting of maximum peak power can be driven by various factors, including organization's energy efficiency guidelines, sustainability requirements, regulatory compliance mandates, or the like. For example, organizations with strict environmental policies may prioritize lower power consumption to meet sustainability goals, while others may adjust maximum peak power settings based on operational demands and peak usage periods. Additionally, industry standards and regional energy regulations can also influence how organizations configure network devices to align with energy management guidelines. The power management controller 214 may be configured to dynamically regulate power usage metrics of the network devices 204A, 204B to ensure that the network devices 204A, 204B operate below corresponding threshold values that define their maximum peak power settings. For the sake of brevity, various operations performed by the power management controller 214 for dynamic power regulation may be described with respect to the network device 204B.

In an example embodiment shown in FIG. 2, the power management controller 214 may be configured to monitor one or more power usage metrics 216 of the network device 204B. The power management controller 214 can monitor the one or more power usage metrics in real time or near real time. Further, the power management controller 214 can monitor the one or more power usage metrics at a plurality of periodic time intervals. In other words, the power management controller 214 can monitor the one or more power usage metrics, with power data analysis being performed through sampling, filtering, grouping, classification, or continuous techniques. At least one power usage metric of the one or more power usage metrics may correspond to a real-time or near real time power consumption by the network device 204B. The one or more power usage metrics 216 may further include one or more of an average data byte size handled by the network device 204B, an instantaneous total bandwidth utilized by the network device 204B, or the like.

In yet more embodiments, the power management controller 214 may be configured to compare the at least one power usage metric with the threshold value associated with the network device 204B. In other words, the power management controller 214 may compare a current power consumption of the network device 204B with the maximum peak power setting of the network device 204B. Based on a result of the comparison, the power management controller 214 may determine whether the at least one power usage metric is greater than or equal to the threshold value. In other words, the power management controller 214 may determine whether the network device 204B is operating below the maximum peak power setting or not based on the result of the comparison. In a scenario where the power management controller 214 determines that the network device 204B is operating below the maximum peak power setting, the power management controller 214 may continue comparing the current power consumption of the network device 204B with the maximum peak power setting, until the maximum peak power setting is breached or exceeded.

However in a scenario where the power management controller 214 determines that the at least one power usage metric (e.g., the current power consumption) is greater than or equal to the threshold value (e.g., the maximum peak power setting), the power management controller 214 may detect a power surge event for the network device 204B. In several embodiments, based on the detection of the power surge event, the power management controller 214 may be configured to mimic a congestion event for the network device 204B. In other words, the power management controller 214 may mimic (or simulate) one or more conditions that indicate occurrence of the congestion event.

In an example embodiments, to mimic the congestion event, the power management controller 214 may be further configured to determine the current queue depth 212 of the data queue 210. Further, the power management controller 214 may determine a modified value 210B for the congestion threshold based on the current queue depth 212. For example, the determined modified value 210B may be less than the current queue depth 212. The power management controller 214 may be further configured to reduce the congestion threshold of the data queue 210 from the initial value 210A to the modified value 210B. In an example, the power management controller 214 may generate a control signal 218 to change the congestion threshold of the data queue 210 from the initial value 210A to the modified value 210B. In other words, the power management controller 214 resets the maximum buffer capacity of the data queue 210 to the modified value 210B, which is less than the current queue depth 212 of the data queue 210, thus mimicking (or simulating) the congestion event. In other words, the power management controller 214 may mimic or simulate the congestion event by artificially forcing a breach of the congestion threshold of the data queue 210 when the network device 204B approaches or exceeds the maximum peak power setting.

Due to the occurrence of the mimicked congestion event, the congestion management protocol or the flow control protocol enabled on the network device 204B is activated or triggered. In further embodiments, the activation of the congestion management protocol or the flow control protocol may reduce the initial data throughput of the network device 204B at the time of the power surge event to a diminished data throughput. For example, in an example embodiments when ECN is activated, the network device 204B may ECN mark one or more data packets and transmit the ECN-marked data packets to the receiving device 206. In response to receiving the ECN-marked data packets, the receiving device 206 may transmit a feedback signal 220 to the sending device 202 to reduce data transmission rate. Based on the feedback signal 220, the sending device 202 may reduce the data transmission rate. As a result of the activation of the congestion management protocol or the flow control protocol on the network device 204B, the sending device 202 may transmit a traffic flow 222 with the reduced data transmission rate, which may further reduce the initial data throughput of the network device 204B to the diminished data throughput.

In numerous embodiments, the current queue depth 212 can be an actual queue depth of the data queue 210. In numerous additional embodiments, the current queue depth 212 can be a shadow queue depth. The actual queue depth may represent a true queue depth of queued data packets in the data queue 210, while the shadow queue depth may be an adaptive representation of the actual queue depth that factors in variables defined by the power management controller 214. For example, the shadow queue depth may be determined by applying arithmetic operations (such as addition, subtraction, multiplication, division, or combinations thereof) to the actual queue depth of the data queue 210, with a shadow queue factor defined based on input/output load changes, efficiency metrics, and power factor of the network device 204B. In some embodiments, the shadow queue factor can be defined dynamically. For example, the power management controller 214 may adjust the shadow queue factor based on, for example, fluctuations in network traffic, power-related parameters of the network device 204B, table lookups, interpolations, formulas, protocols, user-defined parameters, or the like. In stable conditions, the power management controller 214 may decrease the shadow queue factor, or may allow the shadow queue factor to default to zero, making the shadow queue depth equivalent to the actual queue depth. In some additional embodiments, the shadow queue factor can be defined statically. For example, the shadow queue factor can be a predefined constant.

Though in FIG. 2 the data queue 210 is shown to be included in the network device 204B, the scope of disclosure is not limited to it. In many additional embodiments, a centralized controller in the network 200 may be configured to collect and analyze queue metrics (e.g., queue depths) from a group of network devices (e.g., the network devices 204A, 204B) in the network 200 and orchestrate a centralized queue for the group of network devices. In such embodiments, the power management controller 214 may mimic or simulate the congestion event by artificially forcing a breach of a congestion threshold of the centralized queue when any group member of the of the group of network devices approaches or exceeds a corresponding maximum peak power setting.

Although a specific embodiment for a schematic block diagram of an example network 200 suitable for carrying out the various steps, processes, methods, and operations described herein is discussed with respect to FIG. 2, any of a variety of systems and/or processes may be utilized in accordance with embodiments of the disclosure. For example, the power management controller 214 may be external to the network devices 204A, 204B and may be communicatively coupled to the network devices 204A, 204B. In such embodiments, the power management controller 214 may receive the one or more power usage metrics from a power-o-meter in the network devices 204A, 204B. The power-o-meter may be a logic implemented on the network devices 204A, 204B to accurately collect and maintain real-time power usage metrics. The power-o-meter may serve as a data recorder that continuously or periodically aggregates and updates cumulative power usage metrics of the network devices 204A, 204B in the network 200. The collected power usage metrics may be stored in a secure location, which can be integrated into different platforms such as a CPU, an FPGA, custom silicon chips, microcontroller, or a cloud solution. Further examples of the secure location may include hardware security modules that are cryptographically secure with corresponding private and public keys such that the storage is hardened and tamper resistant. The elements depicted in FIG. 2 may also be interchangeable with other elements of FIG. 1 and FIGS. 3-12 as required to realize a particularly desired embodiment.

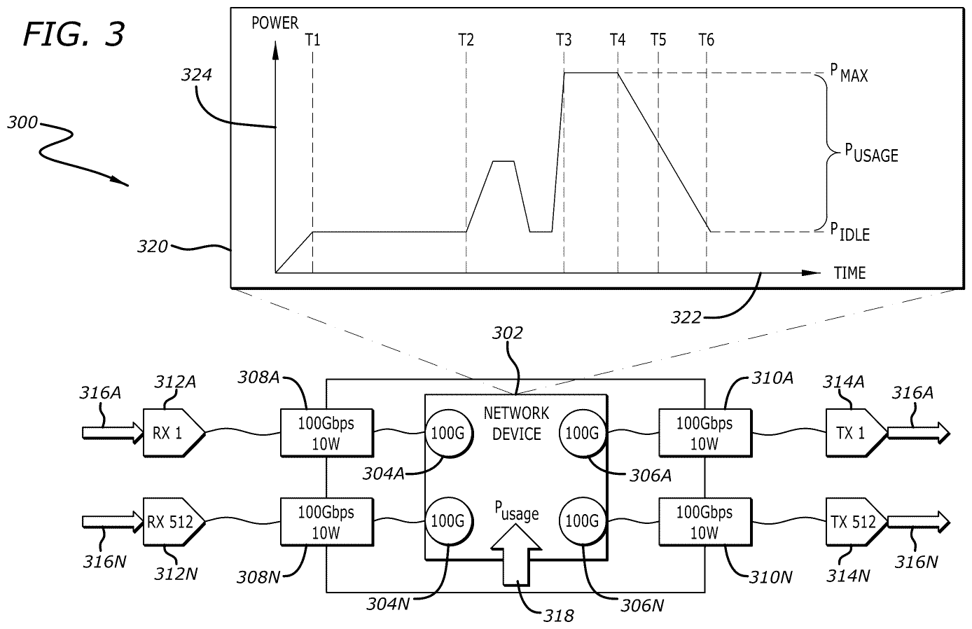

Referring to FIG. 3, a schematic diagram 300 illustrating dynamic power regulation in a network device in accordance with various embodiments of the disclosure is shown. In many embodiments, the network device 302 may be a switch, for example, a leaf switch, a spine switch, or the like. In the example embodiment shown in FIG. 3, the network device 302 may include a plurality of components such as a plurality of receiving (RX) links 304A-304N, a plurality of transmitting (TX) links 306A-306N, a plurality of RX ports 308A-308N, and a plurality of TX ports 310A-310N. The network device 302 may further include a plurality of receivers 312A-312N that can receive traffic flows 316A-316N, each including a plurality of data packets, from external sources and a plurality of transmitters 314A-314N that can forward the received traffic flows 316A-316N to one or more destination devices. The network device 302 may further include a power usage indicator 318 that may indicate a power consumption associated with the network device 302.

The plurality of receivers 312A-312N may receive respective traffic flows 316A-316N at specific data transmission rates. In a non-limiting example, the plurality of RX ports 308A-308N is shown include 100 Gbps ports with a specified power consumption of 10 W each. Thus, the plurality of receivers 312A-312N can receive the traffic flows 316A-316N of up to 100 Gbps or less and provide to the respective plurality of RX ports 308A-308N. For example, a receiver 312A may receive a traffic flow 316A and provide to an RX port 308A. Likewise, another receiver 312N may receive another traffic flow 316N and provide to an RX port 308N. In FIG. 3, the network device 302 is shown to include 512 receivers 312A-312N, labeled as “RX 1”-“RX 512”, in a non-limiting example.

The plurality of RX links 304A-304N may refer to internal links of the network device 302 that receive the traffic flows 316A-316N from the plurality of RX ports 308A-308N. The plurality of RX links 304A-304N may be configured to transport the plurality of data packets of the traffic flows 316A-316N to various processing units in the network device 302 for making routing decisions. In FIG. 3, the plurality of RX links 304A-304N is shown to be capable of handling traffic flows of up to 100 Gbps or less. Once the routing decisions are made, the processed plurality of data packets from the processing units is transported to the respective plurality of TX links 306A-306N, which in turn may provide the traffic flows 316A-316N to the respective plurality of TX ports 310A-310N. In other words, the plurality of TX links 306A-306N may refer to internal links of the network device 302 that receive processed traffic flows 316A-316N from the processing units in the network device 302 and provide to the plurality of TX ports 310A-310N. The plurality of TX ports 310A-310N may then forward the traffic flows 316A-316N to the plurality of transmitters 314A-314N for delivery to the designated one or more destination devices. In a non-limiting example, the plurality of TX ports 310A-310N is shown to include 100 Gbps ports with a specified power consumption of 10 W each. Thus, the plurality of transmitters 314A-314N can transmit the traffic flows 316A-316N of up to 100 Gbps or less. In many embodiments, the power usage indicator 318 may be configured to indicate a value of power consumption of the network device 302, for example, to handle the traffic flows 316A-316N.

In a number of embodiments, the network device 302 may be equipped with a power management logic that may facilitate dynamic power regulation in the network device 302. For example, the power management logic may be configured to monitor one or more power usage metrics associated with the network device 302. In an example, the power management logic may monitor the one or more power usage metrics at periodic time intervals. In another example, the power management logic may monitor the one or more power usage metrics as time-series data. The power management logic may be further configured to store values of the one or more power usage metrics in a database. The one or more power usage metrics may include, for example, a running average data byte size, instantaneous total bandwidth, and power consumption of the network device 302. In many further embodiments, the power management logic may monitor the data byte size, the bandwidth consumption, and the power consumption of the network device 302 and derive the one or more power usage metrics by applying various functions (for example, running or time window average, maximum, minimum, or user defined functions that can be continuous or sampled) on the monitored data byte size, bandwidth consumption, and power consumption.

In an example scenario, during a first time interval, the power management logic may be configured to monitor instantaneous total bandwidth consumed by the network device 302 for processing the traffic flows 316A-316N. Further, during the first time interval the power management logic may be configured to monitor data byte sizes of data packets in the traffic flows 316A-316N and determine a running average of the tracked data byte sizes. Further, the power management logic may correlate the instantaneous total bandwidth with the determined running average of data byte sizes. By correlating the instantaneous total bandwidth with the determined running average of data byte sizes, the power management logic may deduce an impact of fluctuations in data usage on total bandwidth consumption. Further, the power management logic may be configured to monitor the power consumption of the network device 302 during the first time interval. In an example, the power management logic may obtain a reading from a power supply unit (PSU) in the network device 302 to monitor the power consumption of the network device 302 during the first time interval. In a variety of embodiments, the power management logic may be further configured to store values of the monitored instantaneous total bandwidth, the running average of data byte sizes, and the power consumption of the network device 302 in the database along with a time stamp indicating the first time interval. For example, the database can be a tabular database where each entry is organized into columns that represent distinct variables such as the running average of data byte sizes, the instantaneous total bandwidth consumed, the power consumed by the network device 302, and the timestamp of monitoring. Each row in the database may correspond to a unique timestamp, allowing for precise recording of the one or more power usage metrics of the network device 302. The power management logic may repeat the monitoring of the one or more power usage metrics at a next time interval.

In additional embodiments, the power management logic may be configured to dynamically regulate the power consumption of the network device 302 to ensure that the network device 302 operates below a preset threshold value, for example, a maximum peak power setting of the network device 302. The power management logic may leverage one or more congestion control protocols or flow control protocols enabled on the network device 302 to dynamically regulate the power consumption of the network device 302. In the example scenario shown in FIG. 3, a graph 320 may depict power consumption of the network device 302 at different time instances. X-axis 322 of the graph 320 may correspond to a time axis, while Y-axis 324 may correspond to the power consumption (labeled as “P_{USAGE}” in the graph 320) by the network device 302. The graph 320 may illustrate how power consumption in the network device 302 fluctuates with changes in traffic flow over time. Further, the threshold value is shown as “P_{MAX}” in the graph 320.

During a time interval T₁-T₂, the network device 302 may be in an idle state. In the idle state, the network device 302 may consume a baseline power (or static power). That is to say, the network device 302 may be operational but not currently processing significant traffic. For example, during T₁-T₂, the network device 302 may not receive any traffic flow. Even in idle states, the network device 302 may consume some power to stay operational. In other words, the plurality of components of the network device 302 may have to remain active to handle traffic flow at any time. Thus, during T₁-T₂, the power usage indicator 318 may indicate a static power “P_{IDLE}” consumed by the network device 302. For example, during T₁-T₂, the power usage indicator 318 may indicate that the network device 302 consumes 1,200 Watts (W) as P_{IDLE}. In more embodiments, the power management logic may be configured to compare the power consumption during T₁-T₂ with the threshold value. In an example, the threshold value may be set as 1,800 W. Thus, during T₁-T₂, the power management logic may determine, based on a result of the comparison, that the power consumption “P_{IDLE}” is less than the threshold value, and hence the network device 302 may continue with its operations.

During a time interval T₂-T₃, network traffic received by the network device 302 may increase. For example, the network device 302 may start receiving the plurality of traffic flows 316A-316N (hereinafter referred to as “the traffic flows 316A-316N”) with data packets of 500 bytes (B) via the plurality of receivers 312A-312N. The received traffic flows 316A-316N may then be processed and forwarded to the destination devices via the plurality of transmitters 314A-314N. Due to the processing of the traffic flows 316A-316N during T₂-T₃, the power consumed by the network device 302 may also increase from “P_{IDLE}” as shown in the graph 320. For example, the power usage indicator 318 may indicate that the network device 302 has consumed 1,600 W during T₂-T₃. Since the power consumption (1,600 W) during T₂-T₃ is still less than the threshold value, the power management logic may allow the network device 302 to continue with its operations.

At time instance T₃, the network device 302 may receive the traffic flows 316A-316N with an unplanned 250 Byte traffic. As a result, the power consumption of the network device 302 at T₃ may increase to, for example, 2,400 W. Since the current power consumption at T₃ is greater than the threshold value “P_{MAX}”, the power management logic may detect a power surge event in the network device 302. Based on the detection of the power surge event, the power management logic may mimic a congestion event for the network device 302 at a time instance T₄. In other words, the power management logic may artificially simulate one or more conditions (for example, filling of a data queue beyond a congestion threshold) that indicate an occurrence of the congestion event. In response to the mimicked congestion event, the congestion management protocol or the flow control protocol enabled on the network device 302 may get activated to reduce an initial data throughput of the network device 302 at the time of the power surge event to a diminished data throughput. Due to reduction in the data throughput of the network device 302 during time interval T₄ to T₅, the power consumption of the network device 302 may also decrease. As shown in FIG. 3, the power consumption (“P_{USAGE}”) of the network device 302 during T₄ to T₅ may decrease and become less than the threshold value “P_{MAX}”. Thus, based on the mimicked congestion event, the network device 302 may recover from the power surge event. At time instance T₆, the traffic flows 316A-316N may terminate and the network device 302 may again reach an idle state where power consumed is “P_{IDLE}”.

In many additional embodiments, the power management logic may adjust the initial data throughput to achieve the diminished data throughput based on priorities, Virtual Local Area Network (VLAN) assignments, or user-defined policies, and can operate in either lossless or lossy modes. The power management logic may control the initial data throughput based on one or more parameters, which may include local router settings, global VLAN configurations, Open Systems Interconnection (OSI) layer levels (e.g., L2, L3, media access control “MAC”, internet protocol “IP”), or responses learned through AI/ML algorithms may be utilized to reduce the data throughput or traffic processing at the network device 302.

In many further embodiments, various thresholds (for example, the congestion threshold, the maximum peak power setting, also referred to as the threshold value) described in the foregoing description can be implemented using single-level thresholds. In many more embodiments, the thresholds (for example, the congestion threshold, the maximum peak power setting, also referred to as the threshold value) may be implemented using multi-level hysteresis thresholds. The use of multi-level hysteresis thresholds may prevent frequent state oscillations. For example, if the congestion threshold is implemented as a single-level threshold, even small fluctuations (e.g., one data packet) in current queue depth can repeatedly trigger and disable congestion controls. Likewise, if the maximum peak power setting is implemented as a single-level threshold, even small fluctuations (e.g., one data packet) in the one or more power usage metrics can repeatedly trigger and disable power surge events.

Although a specific embodiment for dynamic power regulation in a network device suitable for carrying out the various steps, processes, methods, and operations described herein is discussed with respect to FIG. 3, any of a variety of systems and/or processes may be utilized in accordance with embodiments of the disclosure. For example, once the network device 302 recovers from the power surge event, the power management logic may restore the one or more conditions that were artificially simulated to mimic the congestion event. In many further embodiments, instead of a reactive approach, the power management logic may be configured to implement pre-emptive dynamic power regulation by utilizing a machine learning model. In pre-emptive dynamic power regulation, the power management logic may predict an occurrence of a power surge event at a future time instance based on the machine learning model and currently monitored one or more power usage metrics. Thus, the power management logic may mimic the congestion event at a current time instance to prevent the occurrence of the power surge event at the future time instance. The elements depicted in FIG. 3 may also be interchangeable with other elements of FIGS. 1-2 and 4-12 as required to realize a particularly desired embodiment.

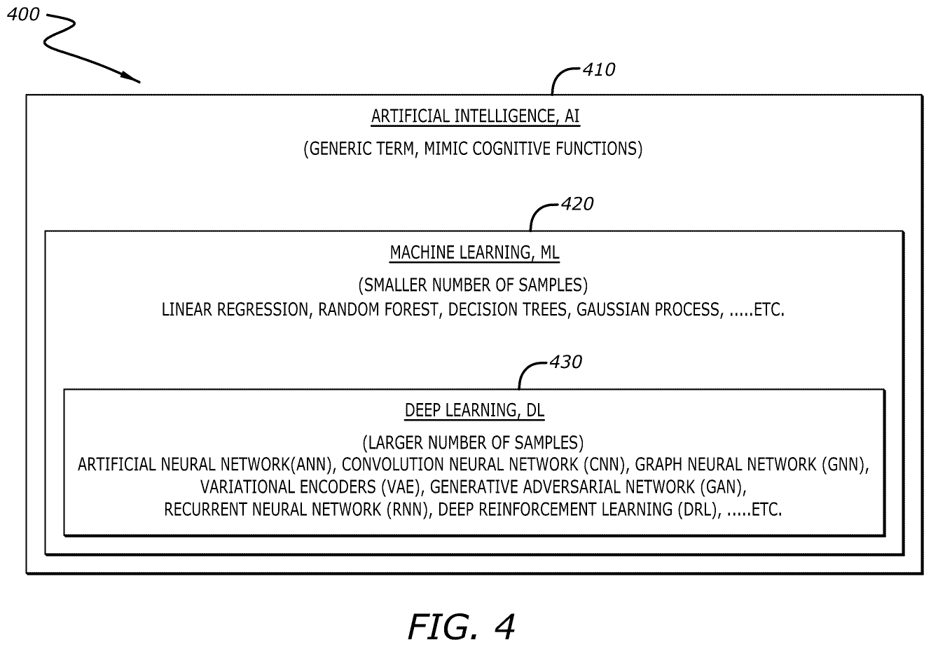

Referring to FIG. 4, a diagram 400 depicting various subsets of artificial intelligence in accordance with various embodiments of the disclosure is shown. Artificial intelligence (AI) 410 is typically understood in the art to be the development of machines and algorithms that mimic human intelligence, for example, by optimizing actions to achieve certain goals. At its core, AI 410 often involves designing algorithms and models that mimic cognitive functions, such as learning, reasoning, problem-solving, perception, and even language understanding. Unlike traditional computer programs that follow a fixed set of instructions, AI systems have the ability to adapt, improve, and make decisions based on input data and environmental interactions.

AI 410 can be considered a generic term because it encompasses a wide range of subfields and techniques, from simple rule-based systems to advanced machine learning and deep learning models. These AI techniques are used to simulate various aspects of human cognition. For example, machine learning (ML) 420 allows computers to learn from data patterns without explicit programming for each task, while natural language processing (NLP) enables machines to understand and generate human language. Deep learning (DL) 430, a more advanced branch of AI, uses neural networks to automatically learn complex patterns from large datasets, akin to the human brain's information processing. This versatility makes AI a powerful tool across diverse applications, including image recognition, autonomous driving, voice assistants, healthcare diagnostics, and materials discovery.

A goal of AI is often to create systems that can function autonomously and intelligently in real-world scenarios. As AI 410 continues to evolve, it can increasingly mirror human-like cognition, enabling machines to not just process data but to “think” in a way that can handle uncertainty, make predictions, and even interact with their surroundings in a meaningful manner. While AI systems are far from achieving the full breadth of human intelligence, their ability to replicate specific cognitive functions makes them invaluable in tackling complex, data-driven challenges.

ML 420 is a subset of Artificial Intelligence (AI) 410 that focuses on the development of algorithms and statistical models that enable computers to learn and make decisions from data without explicit programming. In traditional programming, a computer is given a fixed set of rules to follow, but ML 420 can shift this paradigm by allowing systems to identify patterns, adapt, and improve their performance based on the data they encounter. This data-driven approach makes ML particularly valuable for tasks that are too complex or dynamic to define using straightforward rules, such as, for example, recognizing images, predicting consumer behavior, or diagnosing diseases. In various embodiments described herein, machine-learning methods may be utilized to monitor one or more power usage metrics in a network and detect or predict a power surge event in the network device. The network device may correspond to a leaf switch, a spine switch, a router, a firewall, an access point, or the like that may handle data transmission in a network.

ML models can be configured to analyze large amounts of data to identify trends and relationships that inform their predictions or classifications. The process typically involves three stages: training, validation, and testing. During training, the model learns from a dataset by adjusting its internal parameters to minimize errors between its predictions and the actual results. Techniques like linear regression, decision trees, random forests, and Gaussian processes are commonly used in ML 420. These algorithms can handle various data types, including numerical, categorical, and structured datasets like spreadsheets or grids. One of the key strengths of ML is its ability to generalize from the training data to make accurate predictions on new, unseen data. In a number of embodiments described herein, training data may be generated from historical power usage metric data, historical data throughput, historical threshold data associated with a maximum peak power limit, historical congestion threshold, or the like of one or more network devices.

However, traditional ML methods rely heavily on feature engineering, wherein human experts manually identify the most relevant features or patterns within the data. For example, when using ML 420 for image recognition, an expert might need to extract features like edges, textures, or color patterns before feeding them into a model. This requirement can limit the scalability of traditional ML approaches, especially when dealing with large, unstructured datasets such as images, text, or graphs. Additionally, ML algorithms may often work best when provided with relatively structured data, and they often need a reasonable number of samples (typically more than 100) to learn effectively.

DL 430 is a specialized subset of Machine Learning (ML) 420 that employs multi-layered artificial neural networks to automatically learn complex patterns and representations from large, often unstructured datasets. Inspired by the way the human brain processes information, DL 430 consists of interconnected layers of “neurons” that can adaptively change as they are exposed to more data. Unlike traditional ML methods, which require manual feature engineering to identify key data characteristics, DL models can automatically extract features directly from raw data, such as images, text, or molecular structures. This automated feature extraction allows DL 430 to handle data types and tasks that were previously difficult or impossible for ML models to tackle effectively.

DL models, including Convolutional Neural Networks (CNNs), Graph Neural Networks (GNNs), and Recurrent Neural Networks (RNNs), excel at processing various forms of data. CNNs are particularly effective for image analysis, recognizing intricate patterns in visual inputs, making them indispensable in areas like materials science for analyzing microscopic images or detecting defects in materials. GNNs, on the other hand, are designed to work with graph-based data, such as molecular structures, social networks, or atomic interactions. They can learn the dependencies and relationships within graph-like structures, which is crucial for predicting properties of complex molecules and materials. RNNs and their variants, such as Long Short-Term Memory (LSTM) networks, are suited for sequential data like time series or natural language processing, allowing for the analysis and generation of textual information or the prediction of temporal patterns in scientific research.

One of the defining characteristics of deep learning is its requirement for large datasets (typically over 500 samples for example) to effectively train neural networks. The deep, multi-layered structure of these networks enables them to capture highly complex and abstract representations of the data, but it also demands significant computational power. Techniques like Variational Autoencoders (VAEs) and Generative Adversarial Networks (GANs) add to the versatility of DL by enabling the generation of new data samples that resemble the training set, aiding in areas such as materials discovery and synthetic data creation. Deep Reinforcement Learning (DRL) combines neural networks with decision-making processes to solve problems that involve optimization and control, further expanding DL's application potential. In summary, DL's ability to automatically learn from raw, unstructured data and model intricate patterns makes it a powerful tool in AI, particularly for complex domains like predicting a power surge event and taking corrective measures pre-emptively.

Artificial Neural networks (ANNs or sometimes just NNs) are often a foundation of a DL system. The basic unit of a neural network is typically the perceptron, which can take inputs, assigns weights to these inputs, and combines them to produce an output. The final output is then passed through an activation function (such as, for example, ReLU, sigmoid, or hyperbolic tangent) to introduce non-linearity, which enables the network to model complex patterns.

Neural networks are typically trained through a process of backpropagation, where the system's predictions are compared against the known output, and a loss function is used to measure the difference between the prediction and the actual result. The network's weights can be adjusted through a process called gradient descent, which can be configured to minimize the loss function over time. However, the training process can be prone to problems like overfitting (where the model performs well on the training data but poorly on new data). To counter this, techniques such as regularization (e.g., regularization, dropout), early stopping, and mini-batches can be utilized to prevent the network from becoming overly specialized to the training set.

CNNs are a specific type of DL 430 neural network designed to work particularly well with spatial data, for example image data. However, CNNs can also work with non-image data, for example, power usage metrics of a network device structured as a vector of features as input data. As those skilled in the art will recognize, CNNs typically use specialized layers known as convolutional layers, which apply filters (also known as kernels) to the input data. These filters slide over the input (e.g., power usage metrics), detecting patterns like surges or dips, which are then passed to the next layer for further processing. The advantage of CNNs is their ability to automatically learn and extract relevant features from raw data without the need for manual feature engineering. Furthermore, pooling layers (e.g., max-pooling or average pooling) are often added after convolutional layers to reduce the dimensionality of the data, helping to make the system more efficient while retaining the most important information. After several layers of convolutions and pooling, the CNN can output a prediction, such as a power surge event in the network device.

While CNNs are well-suited for grid-based data. Many real-world problems can involve non-grid data, such as power usage metrics, traffic patterns, and network component dependencies. This type of data may better be represented as a graph, where nodes represent entities (e.g., switches, routers, or individual components such as CPU or ports) and edges represent relationships between them (e.g., power status, utilization rates, or sensor readings). Thus, Graph Neural Networks (GNNs) can be utilized to operate on such graph-based data.

In GNNs, information is passed between nodes through edges in a process called message passing. This allows the network to capture dependencies and relationships within the graph structure. The key feature of GNNs is their ability to aggregate information from neighboring nodes, which is required in predicting properties that depend on the current/local structure, such as predicting a power surge event in a network device.

Generative models aim to learn the underlying distribution of a dataset and generate new samples that resemble the original data. Two common types of generative models are Variational Autoencoders (VAEs) and Generative Adversarial Networks (GANs). VAEs are often configured to work by encoding data into a lower-dimensional latent space and then decoding it back into its original form. This allows for the generation of new data by sampling points from the latent space. This can be utilized when attempting to determine a modified value of a congestion threshold of a data queue from a current queue depth of the data queue to regulate power consumption of the network device within safe power limits, or the like.

Similarly, GANs consist of two components: a generator that creates fake/generated data and a discriminator that tries to distinguish between real and fake data. The two components are trained in a competitive process where the generator tries to “fool” the discriminator, leading to increasingly realistic generated data. This type of process may be utilized to compare the one or more power usage metrics with a threshold value, e.g., a maximum peak power setting of the network device, when attempting to detect a power surge event for the network device.

Reinforcement Learning (RL) involves an agent learning to make decisions by interacting with an environment and receiving feedback (rewards or penalties) based on its actions. Deep Reinforcement Learning (DRL) combines RL with DL techniques, allowing agents to learn from high-dimensional inputs, such as complex congestion event simulations.

For power consumption regulation, DRL can be used in scenarios where an optimal decision needs to be made, such as managing power consumption dynamically by interacting with the network environment, where states represent power usage metrics and traffic conditions, actions involve adjusting parameters such as transmission rates or activating congestion protocols, and rewards are given for maintaining performance while keeping power consumption below the threshold value. The combination of RL and DL can allow for learning from raw data, making it a powerful tool for dynamic and real-time decision-making within a power management device of the network device.

Although a specific embodiment for a diagram 400 depicting various subsets of artificial intelligence suitable for carrying out the various steps, processes, methods, and operations described herein is discussed with respect to FIG. 4, any of a variety of systems and/or processes may be utilized in accordance with embodiments of the disclosure. For example, other subset may be present and available for use within AI 410. Those skilled in the art will recognize that the diagram 400 presented in FIG. 4 is simplified for illustration purposes and various methods and techniques may interact with other areas (ML 420 with DL 430, etc.). The elements depicted in FIG. 4 may also be interchangeable with other elements of FIGS. 1-3 and 5-12 as required to realize a particularly desired embodiment.

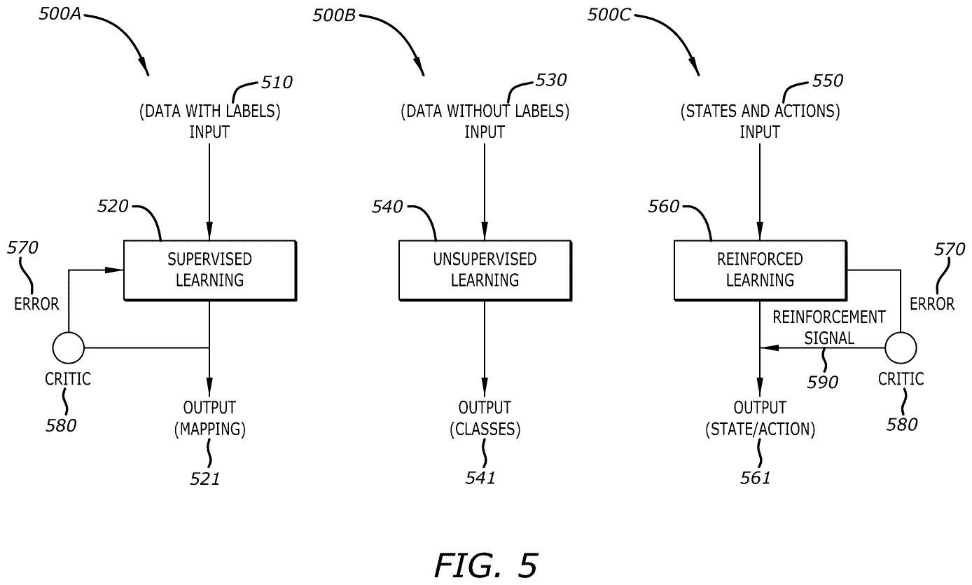

Referring to FIG. 5, different methods of machine-based learning in accordance with various embodiments of the disclosure are shown. In many embodiments, a machine learning model is defined as a mathematical representation of the output of the training process. A machine learning model is often considered similar to computer software designed to recognize patterns or behaviors based on previous experience or data. However, the learning algorithm can discover patterns within the training data, and output an ML model which can capture these patterns and make predictions on new data.

ML models can be understood as a device that has been trained to find patterns within new data and make predictions. These models can be represented as a complex mathematical function that would be impractical for a human to calculate that takes requests in the form of input data, makes predictions on input data, and then provides an output in response. First, these models can be trained over a set of data, and then they are provided an algorithm or other task to reason over data, extract the pattern from feed data and learn from that data. Once the model(s) is/are trained, they can be used to predict a new and previously unseen dataset.

There are various types of machine learning models available based on different business goals and data sets available. Often, based on the desired application, ML models can be configured as or settle into one of three different model types: supervised learning, unsupervised learning, and/or reinforcement learning. Supervised learning can further be broken down into two categories of classification and regression. Likewise, unsupervised learning can be divided into three categories: clustering, association rule, and/or dimensionality reduction.

In the embodiment depicted in FIG. 5, a supervised learning system 500A is shown. The supervised learning system 500A can be configured with a supervised learning model 520 that accepts input data 510 and generates an output 521. However, the output data is often reviewed by a critic 580 that can determine one or more errors 570 that are fed back into the supervised learning model 520 for use in updating.

Supervised learning systems 500A are often considered the simplest machine learning model to understand in which input data (such as training data) has a known label or result as an output. So, the supervised learning model 520 can be understood to work on the principle of input-output pairs. As such, a function can be trained using a training data set, which is then applied to unknown data and makes some predictive performance. Supervised learning is task-based and mostly tested on labeled data sets.

Supervised learning systems 500A may often involve one or more regression problems. In regression problems, the output is a continuous variable. Some commonly used Regression models include linear regression, decision trees, and random forests. Linear regression is typically the most straight forward machine learning model in which a prediction of one output variable is made using one or more input variables. The representation of linear regression can be processed as a linear equation, which combines a set of input values (denoted as x) and a predicted output (denoted as y) for the set of those input values. As those skilled in the art will recognize, this may be represented in the form of a line: Y=bx+c. A typical aim of a linear regression-based model can be to find the optimal fit line that best fits the available data points. Linear regression can be extended to multiple linear regressions (finding a plane of best fit in higher dimensional space) and polynomial regressions (finding the best fit curve).

Decision trees are also popular machine learning models that can be used for both regression and classification problems. A decision tree uses a tree-like structure of decisions along with their possible consequences and outcomes. In this, each internal node is used to represent a test on an attribute while each branch is used to represent the outcome of the test. The more nodes a decision tree has, the more accurate the result will be. This may be used when making decisions related to detecting/predicting a power surge event in a network device and setting a threshold value, e.g., a maximum peak power setting, that may help in predicting the power surge event. The advantage of decision trees is that they are intuitive and easy to implement, but may lack accuracy depending on the available computational or time resources available.

Random forests are an ensemble learning method, which may consist of a large number of decision trees. For example, each decision tree in a random forest predicts an outcome, and the prediction with the majority of votes is considered as the outcome. A random forest model can be used for both regression and classification problems. For the classification task, the outcome of the random forest may be taken from the majority of votes. Whereas in the regression task, the outcome can be taken from the mean or average of the predictions generated by each tree.

Classification models are another type of supervised learning, which can be used to generate conclusions from observed values in one or more categorical forms. For example, a classification model can identify whether a certain modified congestion threshold value can mimic a congestion event or not, etc. Classification algorithms can also be used to predict between two or more classes and/or categorize an output into different groups. For these classification systems, a classifier model can be designed that classifies the dataset into different categories, and each category can subsequently be assigned a label. As those skilled in the art will recognize, there are currently two main types of classifications in machine learning: binary and multi-class. Binary classification can be utilized when there are only two possible classes (i.e., yes/no, surge/dip, etc.). Multi-class classification can be utilized when there are more than two possible classes, thus requiring a multi-class classifier.

One of the potential classification processes is logistic regression. Logistic regression can be used to solve various classification problems in machine learning systems. These processes are similar to linear regression but are often used to predict categorical variables. While some variations can be configured to generate a prediction as an output in either “yes” or “no”, 0 or 1, “true” or “false”, etc. However, in some embodiments, the system can instead be configured to not give exact values, but instead provide probabilistic values between zero and one, etc.

Another classification process that can be utilized is a support vector machine (SVM) which is widely used for classification and regression tasks. However, the main aim of SVM is to find the best decision boundaries in an N-dimensional space, which can be utilized to segregate data points into classes, and generate a best decision boundary often known as a hyperplane. SVM processes can select the extreme vector to find a hyperplane, wherein these vectors are known as support vectors.

Naïve Bayes is another popular classification algorithm used in machine learning. This process receives its name as it is based on Bayes theorem and follows the naïve (independent) assumption between the features which is often given as the formula:

$$P ( y \vert X ) = \frac{P ( X \vert y ) * P ( y )}{P ( X )}$$

This formula takes a class or target y and a predictor attribute (X) and calculates a posterior probability P(y|X) of that class given a particular predictor. P(y) is the prior probability of that class, P(X) is the prior probability of the predictor, and P(X|y) is the likelihood or probability of the predictor given the class. As those skilled in the art will recognize, this may be more succinctly understood as the posterior chance being a result of the prior results times the likelihood divided by the evidence available. Each naïve Bayes classifier assumes that the value of a specific variable is independent of any other variable/feature. For example, if data in the network need to be classified based on packets (structured data units for transmission), frames (data link layer sequences with headers and payloads), IP addresses (numerical network identifiers), and MAC addresses (hardware identifiers). So, a data unit having a packet, discovery frame, IP address, and MAC address may be recognized as a data packet sent for discovering a destination device with a specific MAC address in a specific IP network. Here each feature is independent of other features. Likewise, various embodiments herein can classify based on power usage metric, threshold data, data throughput, type of network device, etc.

Again, in the embodiment depicted in FIG. 5, an unsupervised learning system 500B is shown. The unsupervised learning system 500B can be configured with an unsupervised learning model 540 that accepts input data 530 and generates an output 541. Unlike other model types, there are no critics or error signals to process. Unsupervised learning models 540 can implement the learning process opposite to supervised learning, which means it enables the model to learn from an unlabeled training dataset. Based on the unlabeled dataset, the unsupervised learning model 540 can predict the output. Using an unsupervised learning system 500B, the unsupervised learning model 540 can learn hidden patterns from the dataset by itself without any supervision. In various embodiments, unsupervised learning models 540 are often utilized to perform tasks involving clustering, association rule learning, and/or dimensional reduction.

Clustering is an unsupervised learning technique that involves clustering or grouping the available data points into different clusters based on similarities and/or differences. The objects or data points with the most similarities remain in the same group, and they have no or very few similarities from other groups. Clustering algorithms can be used in a variety of different tasks such as, but not limited to image segmentation, statistical data analysis, market segmentation, and the like. Some commonly used clustering algorithms that can be selected include K-means Clustering, hierarchal Clustering, DBSCAN, etc.

Association rule learning is an unsupervised learning technique which finds unique relations among variables within a large data set. In many embodiments, a primary aim of this type of learning algorithm is to find the dependency of one data item on another data item and map those variables accordingly so that it can satisfy some desired outcome. For example, in certain embodiments, an association rule system may be utilized to detect/predict a power surge event based on current power usage metrics of a network device. This algorithm can be applied in power usage or power consumption analysis, energy consumption analysis, market basket analysis, web usage mining, continuous production, etc. However, those skilled in the art will recognize that other scenarios may be available based on the desired application. Some popular algorithms of association rule learning are Apriori Algorithm, Eclat, and FP-growth algorithm.

In additional embodiments, the number of features/variables present in a dataset can be understood as the dimensionality of the dataset, and the technique used to reduce the dimensionality is known as a dimensionality reduction technique. Although more data provides more accurate results, it can also affect the performance of the model/algorithm, such as yielding overfitting outcomes, etc. In such cases, dimensionality reduction techniques can be utilized. It is often desired that this process involves converting the higher dimensions dataset into lesser dimensions dataset while also ensuring that the ensuing results provide similar information. Different dimensionality reduction methods can be utilized, such as, but not limited to, PCA (Principal Component Analysis), Singular Value Decomposition (SVD), etc.

Finally, in the embodiment depicted in FIG. 5, a reinforcement learning system 500C is shown. The reinforcement learning system 500C can be configured with a reinforcement learning model 560 that accepts input data 550 and generates an output 561. In reinforcement learning, the reinforcement learning model 560 learns actions for a given set of states that lead to a goal state. In the embodiment depicted in FIG. 5, a critic 580 can receive or otherwise notice an error 570 within the reinforcement learning model 560 actions, and adjust, using a reinforcement signal 590, the outcome/output such that the “reward” or “punishment” is adjusted to better model the future behaviors or processing of the reinforcement learning model 560.

It is a feedback-based learning model that can takes feedback signals after each state or action by interacting with the environment. This feedback works as a reward (positive for each good action and negative for each bad action), and the agent's goal is to maximize the positive rewards to improve their performance. The behavior of the model in reinforcement learning is similar to human learning, as humans learn things by experiences as feedback and interact with the environment. Popular methods of reinforcement learning including q-learning, state-action-reward-state-action (SARSA), and deep Q network.

Q-learning is one of the popular model-free algorithms of reinforcement learning, which is based on the Bellman equation. It often aims to learn the policy that can help the AI agent to take the best action for maximizing the reward under a specific circumstance. It can incorporate Q values for each state-action pair that indicate the reward to following a given state path, and it tries to maximize that Q-value.

SARSA is an on-policy algorithm based on the Markov decision process. In many embodiments, it can use the action performed by the current policy to learn the Q-value. The SARSA algorithm stands for State Action Reward State Action, which symbolizes the tuple (s, a, r, s′, a′). Finally, deep Q neural networking (or DQN) is Q-learning within a neural network. It can be deployed within a big state space environment where defining a Q-table would be a complex task. So, in these embodiments, rather than using a Q-table, the neural network instead utilizes Q-values for each action based on the state.

Although a specific embodiment for different methods of machine-based learning suitable for carrying out the various steps, processes, methods, and operations described herein is discussed with respect to FIG. 5, any of a variety of systems and/or processes may be utilized in accordance with embodiments of the disclosure. For example, those skilled in the art will recognize that methods of learning described herein are generalized and may incorporate other types developed as well as a combination of one or more methods based on the goals of the desired application. The elements depicted in FIG. 5 may also be interchangeable with other elements of FIGS. 1-4 and 6-12 as required to realize a particularly desired embodiment.

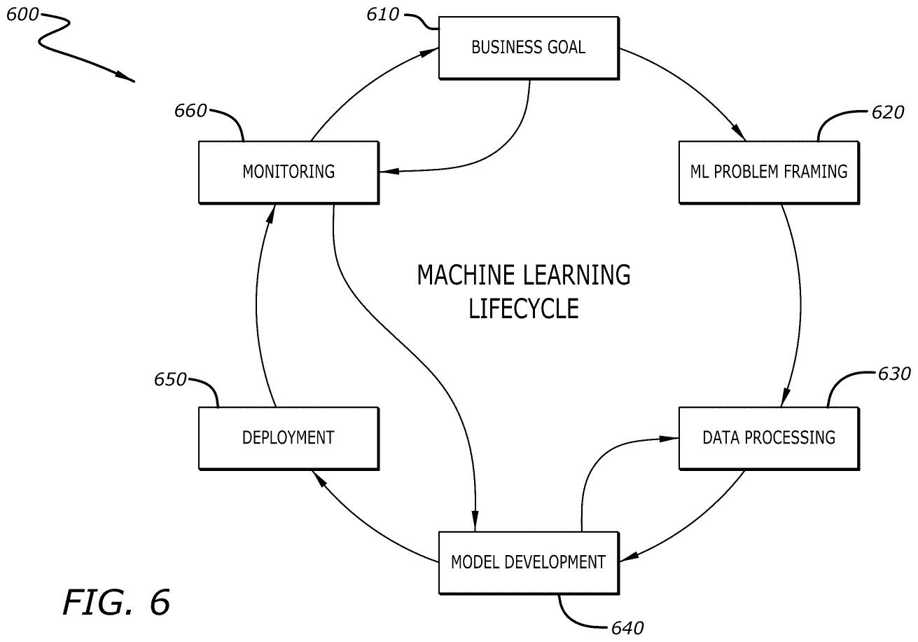

Referring to FIG. 6, a machine learning lifecycle 600 in accordance with various embodiments of the disclosure is shown. During the development of machine learning systems, the embodiment depicted in FIG. 6 can provide a framework for how to structure the design and maintenance of these systems. This machine learning lifecycle 600 outlines various stages involved in building, deploying, and improving ML models to solve real-world problems. By following this structured process, businesses and organizations can ensure that their machine learning projects align with strategic goals, use data effectively, and adapt to changing conditions over time. This machine learning lifecycle 600 emphasizes that developing a machine learning model is not a one-time effort but an iterative process requiring ongoing monitoring and adjustment. The feedback loop inherent in the machine learning lifecycle 600 allows for continual refinement and optimization of models to maintain their accuracy and relevance.

In many embodiments, a first stage of the machine learning lifecycle 600 is identifying the business goal 610, which sets the overall direction and purpose of the ML project. This can involve understanding the specific problems or opportunities within the business or project that machine learning can address. A clear business goal 610 ensures that the project remains focused on delivering tangible value, whether it is predicting a power surge event, mimicking a congestion event, activating congestion management protocols, or dynamic power consumption regulation of network devices. Without a well-defined goal, it can be challenging to align the subsequent stages of the ML lifecycle 600, as the choice of model, data processing methods, and performance metrics can all depend on what the business aims to achieve.

Establishing a proper business goal 610 can also involve engaging with key stakeholders and developers to gather requirements and set success criteria. It can provide a roadmap that outlines what success looks like and helps in framing the ML problem. For example, if the goal is to dynamically regulate power consumption, the project might focus on building a predictive model that identifies potential bottlenecks, allowing a power management controller to intervene proactively. Clearly defined goals not only help guide the project but also provide benchmarks for evaluating the effectiveness of the deployed model once it enters production.

Once the business goal 610 is established, various embodiments take a next step involving ML problem framing 620, wherein the goal is translated into a specific machine learning task. This can involve selecting the appropriate type of ML problem, such as classification, regression, clustering, or recommendation, and defining the target variables or outputs. For example, if the goal is to identify data queue bottlenecks, the problem can be framed as a binary classification task where the model predicts whether a particular value of congestion threshold will lead to triggering of a congestion event. Proper problem framing can be important as it determines the particular data requirements, choice of model, and evaluation metrics.

During this stage, it is also prudent to consider the constraints and assumptions that may affect the model's development. This might include data availability, computational resources, ethical considerations, or regulatory compliance. Properly framing the problem ensures that the model development aligns with the business's needs and that the problem is broken down into manageable steps, ultimately increasing the project's chances of success.

Data processing 630 is a step in many embodiments where raw data is collected, cleaned, and transformed into a format suitable for machine learning. This step can involve gathering data from various sources, removing errors or inconsistencies, handling missing values, and normalizing or scaling features to ensure that the model can learn effectively. Feature engineering is often a part of this stage, where new features are derived from the raw data to capture more relevant information and improve model performance.

The quality and preparation of the utilized data can significantly impact the model's accuracy and reliability. Inadequate or poorly processed data can lead to biased or inaccurate predictions, no matter how advanced the model is. Hence, data processing 630 can require or at least benefit from careful planning and iterative refinement. Once the data is processed, it is typically split into training, validation, and test sets to develop and evaluate the model, ensuring that it generalizes well to new, unseen data.

Model development 640 is a phase in a number of embodiments where machine learning algorithms are selected, trained, and refined to create a model that addresses the framed problem. This stage can involve choosing the appropriate algorithm (e.g., decision trees, neural networks, support vector machines), setting up the model's architecture, and defining hyperparameters that will guide the training process. The model is trained on the processed data to identify patterns and relationships that allow it to make predictions or decisions.

During model development 640, the model can be evaluated using the validation dataset to fine-tune its parameters and improve performance. Techniques like cross-validation, regularization, and hyperparameter tuning can be used to prevent overfitting and ensure the model generalizes well. If proper steps are taken, the result is a model that, once it meets predefined performance metrics, is ready for deployment in a real-world environment. However, this process often involves several iterations to optimize the model for the specific business goal, indicated by the arrow back to data processing 630.

In further embodiments, deployment 650 is the stage where the developed model is integrated into the production environment to perform its intended tasks. This phase may involve setting up the necessary infrastructure, such as APIs or cloud-based services, to allow the model(s) to process live data and generate predictions. Deployment 650 can transform the model from a research tool into a functional component of a business process or product, providing real-time insights, automations, or decisions.

Proper deployment 650 can also include setting up mechanisms for logging, error handling, and user access. Since real-world environments are often dynamic and differ from training conditions, deployment 650 may require continuous adaptation and updates to ensure the model(s) operates efficiently. This step can be important because a model's success is not only determined by its performance metrics but also by its ability to provide actionable results that align with the business goal 610.

In more embodiments, monitoring 660 is the ongoing process of tracking the model's performance and behavior after deployment. It involves collecting data on the model's predictions, accuracy, latency, and error rates to detect issues such as concept drift, where changes in the underlying data patterns can degrade the model's accuracy. By continuously monitoring 660, teams can identify when the model's performance drops and requires retraining or adjustments to align with the evolving data.

Monitoring 660 can also encompass aspects like user feedback, security, and compliance, ensuring that the model remains effective, reliable, and ethical in its application. It may serve as the feedback loop in the lifecycle, where insights gained from monitoring feed back into the earlier stages, particularly data processing 630 and model development 640, to refine the model(s) as needed. This iterative process allows the machine learning system to adapt and maintain its alignment with the original business goal 610 over time.

Although a specific embodiment for a machine learning lifecycle 600 suitable for carrying out the various steps, processes, methods, and operations described herein is discussed with respect to FIG. 6, any of a variety of systems and/or processes may be utilized in accordance with embodiments of the disclosure. For example, the particular route of development of the model(s) may not follow this cycle completely. As those skilled in the art will recognize, there are a variety of ways to develop AI products that include various iterative steps that aide in development and refinement of different model(s). The elements depicted in FIG. 6 may also be interchangeable with other elements of FIGS. 1-5 and 7-12 as required to realize a particularly desired embodiment.

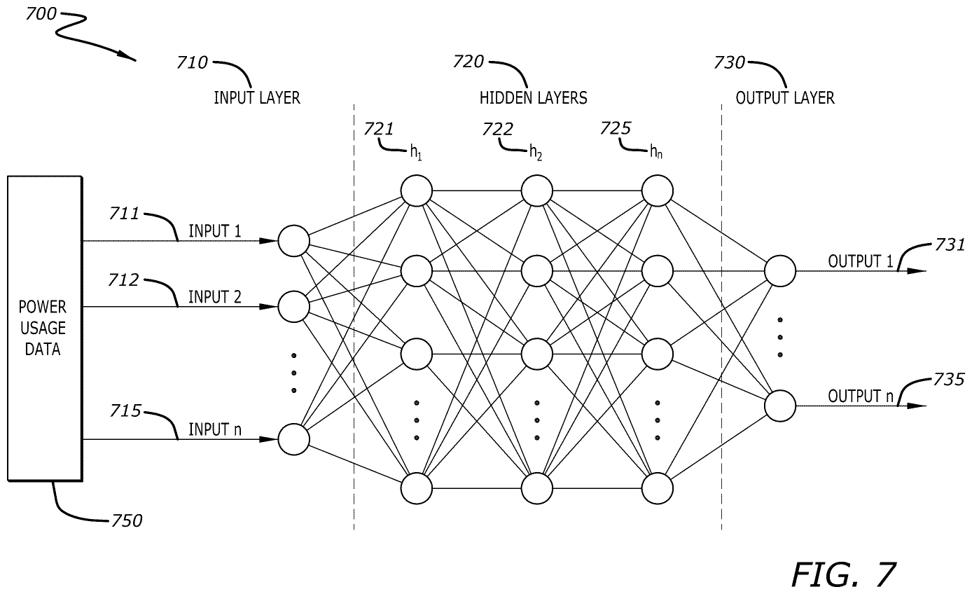

Referring to FIG. 7, an exemplary neural network 700 in accordance with various embodiments of the disclosure is shown. The embodiment depicted specifically depicts a feedforward neural network with multiple layers. This type of network consists of an input layer 710, one or more hidden layers 720, and an output layer 730. Each layer contains nodes (or neurons) that are interconnected, representing how data flows through the network. The input layer 710 can receive raw data, which is then processed by the hidden layers 720 through weighted connections and activation functions. These hidden layers 720 can enable the network to learn complex patterns and relationships within the data.

The final output layer 730 produces the network's predictions or classifications based on the processed input. The interconnected nature of the nodes allows the neural network 700 to learn from data during training by adjusting the weights of connections to minimize prediction errors. This structure is the foundation of deep learning models, as adding more hidden layers 720 can create a deep neural network, capable of tackling highly complex tasks such as image recognition, natural language processing, and pattern detection in large datasets.

A perceptron or a single artificial neuron is the building block of artificial neural networks (ANNs) and can perform forward propagation of information. For a set of inputs to the perceptron, weights (and biases to shift wights) can be assigned. These inputs and weights can be multiplied out correspondingly together to get a sum output. Those skilled in the art will recognize tools such as, but not limited to, PyTorch, Tensorflow, and MXNet as training packages for common neural network tasks. However, it is contemplated that other tools may be developed specifically for the neural network tasks related to the embodiments described herein.

In additional embodiments, the weight matrices of a neural network can be initialized randomly or obtained from a pre-trained model. These weight matrices can be multiplied with the input matrix (or output from a previous layer) and subjected to a nonlinear activation function to yield updated representations, which are often referred to as activations or feature maps. The loss function (also known as an objective function or empirical risk) can often be calculated by comparing the output of the neural network and the known target value data.

Feedforward networks, such as the neural network 700 depicted in the embodiment of FIG. 7, are often configured as neural networks where information moves in one direction, from the input layer through the hidden layers to the output layer, without any cycles or loops. They are primarily used for tasks such as classification, regression, and simple pattern recognition, where each input is processed independently of others. In contrast, backpropagation is not a separate type of network but rather a training algorithm commonly used in both feedforward and other types of networks, like recurrent neural networks (RNNs).

Backpropagation involves adjusting the weights of the network in the reverse direction (from output to input) based on the error between the predicted output and the actual target during training. While feedforward describes the structure and data flow within the network, backpropagation is a technique used to optimize the model. Feedforward networks are ideal for straightforward tasks where input-output relationships are not sequential or time-dependent. However, for problems involving learning complex patterns over time, such as speech recognition or time-series analysis, networks that leverage backpropagation for training, like RNNs or deep feedforward networks with many hidden layers, become necessary to capture these intricate dependencies.

Typically, in these network arrangements, the weights are iteratively updated via various methods including, but not limited to, stochastic gradient descent algorithms in order to help minimize the loss function until the desired accuracy is achieved. Most modern deep learning frameworks can facilitate this by using reverse-mode automatic differentiation to obtain the partial derivatives of the loss function with respect to each network parameter through recursive application of the chain rule. Colloquially, this is also known as back-propagation. Common gradient descent algorithms can include, but are not limited to, Stochastic Gradient Descent (SGD), Adam, Adagrad etc. The learning rate is an important parameter in gradient descent. Except for SGD, all other methods use adaptive learning parameter tuning. Depending on the objective such as classification or regression, different loss functions such as Binary Cross Entropy (BCE), Negative Log Likelihood Loss (NLLL) or Mean Squared Error (MSE) can be used.

Neural network architecture is commonly used for a wide range of tasks in fields such as network power consumption monitoring, computer vision, natural language processing, financial forecasting, and materials science. For instance, it can be employed to recognize dips, or surges in power consumption patterns or energy usage by network devices, recognize patterns in fluctuations in power usage caused by specific data throughputs of a network device, such as identifying a power surge or an energy spike, or to classify power usage metrics into different categories based on the type of network components. It is also useful in regression problems, such as predicting stock prices or energy consumption, where input features can be processed to output continuous values. However, this is a general example of an artificial intelligence (AI) model, illustrating how a feedforward neural network works. Depending on the problem, other methods and models may be more appropriate. For example, convolutional neural networks (CNNs) are often used for image processing tasks, while recurrent neural networks (RNNs) are suitable for sequential data like time series data or text. Additionally, simpler models like linear regression, decision trees, or support vector machines (SVMs) may be sufficient if the problem is less complex, or the dataset is relatively small. The embodiment depicted in FIG. 7 is presented as an exemplary ML solution that may be deployed within one or more methods or systems described herein.

In many embodiments, the input layer 710 is the first layer in a neural network 700 and serves as the initial point where raw data is introduced into the model. Each node (or neuron) in this layer represents an individual feature or variable from the dataset, allowing the network to receive and process various types of data, such as power usage metric, throughput, or threshold data. For instance, in power surge detection tasks, the input layer can consist of nodes that correspond to one or more power usage metrics associated with power consumption of internal components of a network device, providing the network with the visual information needed to identify objects or patterns. The number of nodes in the input layer directly depends on the number of features present in the dataset. If there are one-hundred features in the data, the input layer will typically have one-hundred nodes, each conveying one piece of the information to the subsequent layers. In more embodiments, the inputs of the neural network 700 are generally scaled i.e., normalized to have a zero mean and/or unit standard deviation. Scaling can also be applied to the input of hidden layers (using batch or layer normalization) to improve the stability of neural network 700.

Unlike the hidden layers 720 and output layers 730, the input layer 710 typically does not perform any computations or transformations on the data. Its primary function is often to pass the input data to the next layer in the network, the first hidden layer 721. However, it is often desired that the data fed into this layer is preprocessed appropriately, such as being normalized or standardized, to ensure that the neural network can learn efficiently. Proper preprocessing, like scaling numerical values or encoding categorical variables, can help the network process data uniformly, facilitating more stable and faster convergence during training.

The input layer's design depends on the nature of the problem. For example, in power consumption regulation, the input layer may represent power usage metrics encoded as numerical power vectors, while in time-series analysis, each node might represent a data point in a sequence. While the input layer 710 itself does not modify the data, it sets the stage for the neural network to extract complex patterns and relationships through the deeper layers. This flexibility in handling various types of input make the neural network 700 a powerful tool for a diverse set of applications.

With respect to the embodiments described herein, the input layer may be configured with a plurality of inputs providing power usage metric data 750, data throughput, or threshold data. For example, a model can be configured with a first input 711 configured as a first receiver port/buffer/interface of a network device, a second input 712 is configured with a second potential receiver port/buffer/interface of the network device, while additional inputs can be added related to the number of potential receiver ports/buffers/interfaces in the network device. The nth input 715 can be configured in certain embodiments to include the nth receiver port/buffer/interface such that a determination to keep the power consumption of the network device below a threshold value such as maximum peak power setting may be possible. However, as those skilled in the art will recognize, additional setups can be configured such that the inputs can be configured to also include different parameters of the port/buffer/interfaces of the network device, the number of power usage metrics or points of interest in the scene, the congestion threshold values of previous analyses, among other input types, etc.

In a number of embodiments, the neural network 700 comprises a plurality of hidden layers 720. The embodiment depicted in FIG. 7 comprises a first hidden layer 721, a second hidden layer 722, and an nth hidden layer 725, which are denoted as h₁, h₂, and hₙ respectively. In many embodiments, the hidden layers 720 are where the core of the model's learning and pattern recognition occurs. In each hidden layer, individual neurons receive inputs from the previous layer, apply a set of weights, add a bias, and pass the result through an activation function (e.g., ReLU, leaky ReLU, sigmoid, hyperbolic tangent (tanh), Swish, etc.). This process can introduce non-linearity, allowing the network to capture complex patterns in the data that simple linear models cannot. The intricate web of connections among neurons across layers helps the network transform and process input features into representations that become progressively more abstract and useful for making predictions.

The first hidden layer 721 h₁ receives direct input from the input layer, transforming the raw data into an initial set of features. For example, in a power surge detection or prediction task, this layer might begin identifying basic patterns, such as spikes or dips in the power usage patterns of the network device. The output of the first hidden layer 721 is then passed to a second hidden layer 722 h₂, which builds upon the features identified by the first hidden layer 721. This deeper layer might start recognizing more complex patterns, such as shapes or specific object components, by combining the lower-level features identified earlier. This can continue on until a last, nth hidden layer 725 hₙ continues this abstraction process, allowing the network to recognize even higher-level, more detailed features, such as identifying a power surge event or understanding intricate relationships in the input data.

Each hidden layer adds a level of complexity and abstraction to the network's learning capabilities. The multi-layer structure can enable the network to move from recognizing simple patterns in the first hidden layer 721 to highly complex, abstract concepts in the deeper layers. The number of hidden layers and neurons within them can vary depending on the problem's complexity. More hidden layers generally allow the network to model more intricate functions, making deep neural networks especially effective for tasks like image recognition, natural language processing, and complex predictive modeling. However, adding more layers also increases the computational demand and the risk of overfitting, highlighting the need to carefully design and tune these hidden layers for optimal performance.

In various embodiments, the output layer 730 is often the final layer in a neural network and is responsible for producing the network's predictions or classifications based on the information processed through the previous hidden layers 720. Each neuron in the output layer 730 can represent a specific outcome or category that the model can predict. In the embodiment depicted in FIG. 7, the outputs are labeled as “output 1” 731 to “output n” 735, indicating that the network can be designed to have a varying number of outputs depending on the nature of the problem being solved for. For example, in a binary classification task (e.g., detecting a power surge event vs. not detecting a power surge event), there would typically be a single output neuron that provides a probability score for one of the two classes/outcomes. In contrast, for multi-class classification (e.g., categorizing a best congestion threshold value between three or more potential congestion threshold values associated with a data queue), the output layer would contain multiple neurons, each corresponding to a different class.

The number of neurons in the output layer 730 can also designed specifically for other types of tasks, such as regression, where the model can predict continuous values. In such cases, the output layer 730 might contain a single neuron representing a numerical prediction, such as the price of a house or the temperature forecast, etc. Alternatively, in complex applications like multi-label classification (where each input can belong to multiple classes simultaneously), the output layer 730 could have multiple neurons, each representing a different class, with each neuron outputting a probability of the input belonging to that specific class.

The activation function used in the output layer can vary based on the desired output. For binary classification, a sigmoid function is commonly used to produce a probability between 0 and 1. For multi-class classifications, a softmax function can be applied to output a set of probabilities that sum to 1, indicating the most likely class. For regression problems, a linear activation function is often used to output a continuous range of values. The flexibility in designing the output layer allows the neural network 700 to be applied to a wide variety of tasks, from simple binary decisions to complex multi-output predictions, making them a versatile tool in artificial intelligence and machine learning.

Although a specific embodiment for an exemplary neural network suitable for carrying out the various steps, processes, methods, and operations described herein is discussed with respect to FIG. 7, any of a variety of systems and/or processes may be utilized in accordance with embodiments of the disclosure. For example, real-world neural networks are often far more complex, featuring many more layers, nodes, and connections than the simplified structure shown in the embodiment depicted in FIG. 7, which is an illustrative example meant to make it easier to explain the basic concepts of neural networks and how they process information. The specific features and functions described herein are not intended to be limiting to this specific embodiment. Additionally, the elements depicted in FIG. 7 may also be interchangeable with other elements of FIGS. 1-6 and 8-12 as required to realize a particularly desired embodiment.

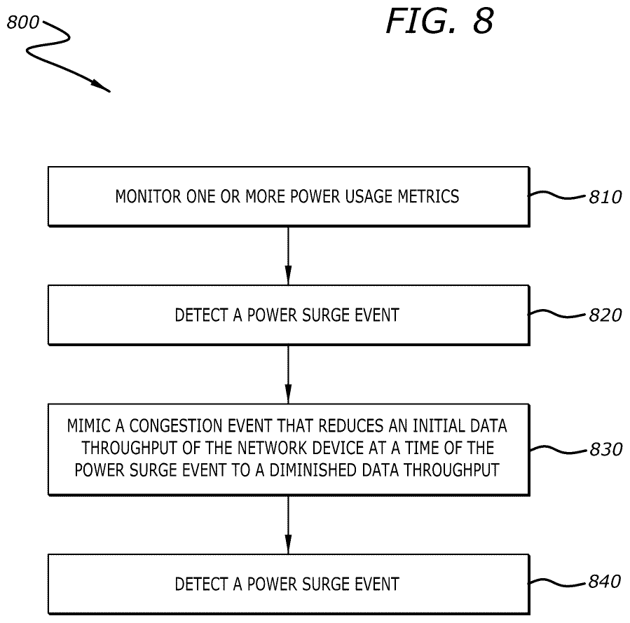

Referring to FIG. 8, a flowchart depicting a process 800 for regulating power consumption in a network device in accordance with various embodiments of the disclosure is shown. Having disclosed a brief introductory description of exemplary systems and networks within FIGS. 1-7, FIG. 8 depicts the process 800 that enables regulation of power consumption in the network device (e.g., leaf switches, spine switches, firewalls, routers, or the like) of a network. The process 800 may be performed at the network device that receives traffic flows for transmission to various other network elements of the network. The network device may itself have a plurality of internal components that consume power to perform switching functionalities for the transmission of data packets of the traffic flows. In a number of embodiments, the process 800 may monitor one or more power usage metrics (block 810). For example, the monitored one or more power usage metrics of the network device may include energy consumption, voltage, and power drawn across the plurality of internal components. The monitored one or more power usage metrics of the network device may further include a running average data byte size, instantaneous total bandwidth consumption, or the like in the network device. In some embodiments, the process 800 may continuously monitor the one or more power usage metrics of the network device as time-series data. In more embodiments, the process 800 may monitor the one or more power usage metrics in real-time or near real-time.

In a number of embodiments, the process 800 may detect a power surge event (block 820). The power surge event may be detected when at least one power usage metric of the one or more power usage metrics exceeds a threshold value. For example, the power surge event may be detected when the power consumption of the network devices becomes greater than or equal to a maximum peak power setting (e.g., the threshold value) of the network device. In yet more embodiments, to detect the power surge event, the process 800 may compare the one or more power usage metrics with the threshold value.

In several embodiments, the process 800 may mimic a congestion event that reduces an initial data throughput of the network device at a time of the power surge event to a diminished data throughput (block 830). Once the power surge is detected, the process 800 may mimic the congestion event. For example, the process 800 may artificially simulate one or more conditions in the network device that may indicate an occurrence of the congestion event. In one or more embodiments, the process 800 may reduce an initial value of a congestion threshold of a data queue in the network device to a modified value that is less than a current queue depth of the data queue. In numerous embodiments, the process 800 may mimic the congestion event based on a congestion management protocol or a flow control protocol enabled on the network device. Thus, when the mimicked congestion event occurs, the congestion management protocol or the flow control protocol enabled on the network device gets activated and results in the reduction of the initial data throughput to the diminished data throughput. In yet more embodiments, the process 800 may utilize information or policies specific to the network device, such as its local traffic load or routing tables, to mimic the congestion event. In still more embodiments, the process 800 may utilize characteristics or policies of a Virtual Local Area Network (VLAN) configured on the network device to mimic the congestion event. In still yet more embodiments, the process 800 may utilize network or flow control policies associated with different OSI layers (such as Layer 2, Layer 3, MAC layer, or the like) associated with the network device to mimic the congestion event. In addition, the reduction of the initial data throughput to the diminished data throughput can be based on a lossless or a lossy operation depending on the one or more conditions that are simulated to mimic the congestion event. Thus, the process 800 may prevent a complete shutdown of the network device and avoid unnecessary disruptions to running applications or services.

In numerous embodiments, the process 800 may regulate a power consumption (block 840). That is to say, power consumption of the network device may be a function of the data throughput of the network device. Thus, as the data throughput increases, power consumption in the network device increases, whereas as the data throughput decreases, power consumption in the network device may also decrease. The process 800 may leverage the congestion management protocol or the flow control protocol enabled on the network device to control data throughput of the network device, and in turn may regulate the power consumption of the network device in real time or in near real time.

Although specific embodiments for regulating power consumption in a network device are described above with respect to FIG. 8, any of a variety of systems and/or processes may be utilized in accordance with embodiments of the disclosure. In a variety of embodiments, the process 800 may monitor the one or more power usage metrics at a plurality of periodic time intervals. The elements depicted in FIG. 8 may also be interchangeable with other elements of FIGS. 1-7 and 9-12 as required to realize a particularly desired embodiment. More details about sustainability aware call routing are described below.

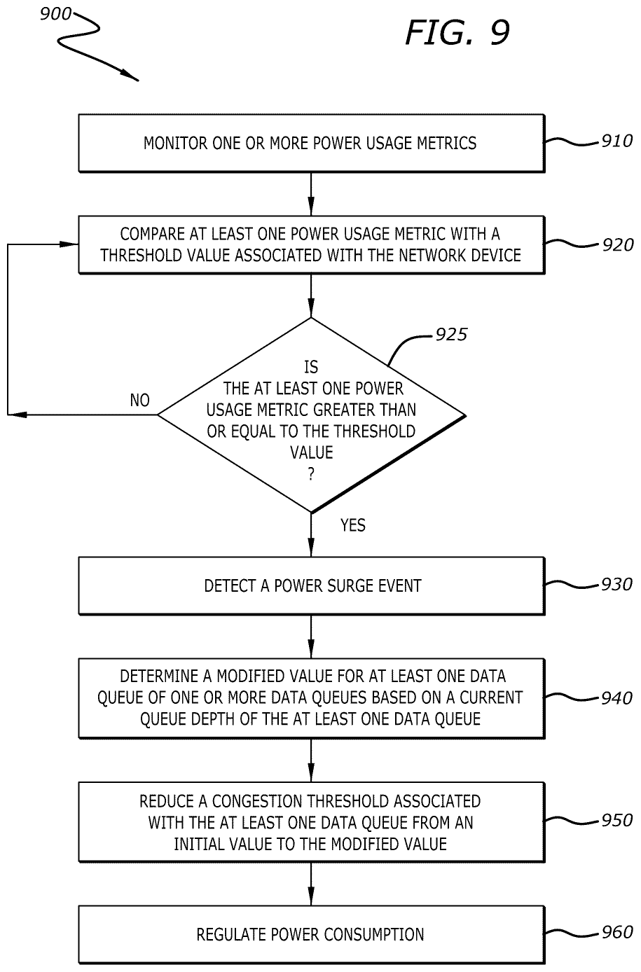

Referring to FIG. 9, a flowchart depicting a process 900 for dynamic regulation of power consumption in a network device in accordance with various embodiments of the disclosure. The network device may correspond to a leaf switch, a spine switch, a firewall, an access point, a router, a processor, or the like that handles data transmission or processing in a network. In modern data centers, these network devices have to exhibit fast switching capabilities in at least terabytes per second to handle, process, and transmit data packets having high data throughput. But sometimes, higher data throughput can cause power surges in the network device which can lead to a shutdown of the network device. In order to prevent such disruption, the process 900 may be performed at the network device to facilitate a proactive dynamic power regulation. In many embodiments, the process 900 may monitor one or more power usage metrics (block 910). For example, at least one power usage metric of the one or more power usage metrics may correspond to a real-time or near real time power consumption by the network device. The one or more power usage metrics of the network device may further include, for example, a voltage or power drawn across a plurality of internal components of the network device. The one or more power usage metrics may further include one or more of an average data byte size handled by the network device or an instantaneous total bandwidth utilized by the network device.

In a variety of embodiments, the process 900 may compare at least one power usage metric with a threshold value associated with the network device (block 920). The threshold value may be indicative of a maximum peak power setting of the network device. For example, the maximum peak power setting defining a maximum power usage limit of the network device may be a configurable parameter. The setting of maximum peak power can be driven by various factors, including organization's energy efficiency guidelines, sustainability requirements, regulatory compliance mandates, or the like. In a number of embodiments, the process 900 may continuously compare the at least one power usage metric with the threshold value. In additional embodiments, the process 900 may compare the at least one power usage metric with the threshold value at periodic intervals of time.

In various embodiments, the process 900 may determine whether the at least one power usage metric is greater than or equal to the threshold value (block 925). In other words, based on a result of the comparison, the process 900 may determine whether the at least one power usage metric is greater than or equal to the threshold value or not. The at least one power usage metric being greater than or equal to the threshold value may indicate that the network device is consuming more power than the maximum power usage limit. While the at least one power usage metric being less than the threshold value may indicate that the network device is operating below the maximum power usage limit. If the at least one power usage metric is less than the threshold value, the process 900 may continue comparing the at least one power usage metric with the threshold value (block 920).

However, if the at least one power usage metric is greater than or equal to the threshold value, in still additional embodiments, the process 900 may detect a power surge event (block 930). The power surge event may be detected in response to determining that the at least one power usage metric is greater than or equal to the threshold value. In other words, the power surge event may be detected when the power consumption of the network device exceeds the threshold value (e.g., the maximum peak power setting defining the maximum power usage limit). For example, when there is a sudden increase in data traffic (such as high-bandwidth activities or heavy application loads), the network device may need to process and transmit increased data. This may increase the switching activity in the network device, leading to a higher power being consumed. When the power consumption increases beyond the threshold value, the power surge event is detected. Early detection of such power surge events may avoid risks such as equipment overheating, tripping of circuit breakers, or even data center downtime.

In additional embodiments, the process 900 may determine a modified value for at least one data queue of one or more data queues based on a current queue depth of the at least one data queue (block 940). The process 900 may monitor the current queue depth (occupancy) of the one or more data queues in the network device. The modified value for the at least one data queue is less than the current queue depth of the at least one data queue.

In several embodiments, the process 900 may reduce a congestion threshold associated with the at least one data queue from an initial value to the modified value (block 950). The at least one data queue may be configured with a congestion threshold that may be indicative of a maximum buffer capacity the data queue can store before the data queue becomes full. For example, the data queue may be configured with the initial value for the congestion threshold. In a scenario, if incoming data packets arrive faster than the network device can process, the at least one data queue may fill up, and if the congestion threshold of the data queue is breached or exceeded, a congestion event may occur. The process 900 may reduce the congestion threshold from the initial value to the modified value, which is less than the current queue depth, to artificially simulate or mimic one or more conditions that can lead to the occurrence of the congestion event in the network device.

In further embodiments, the process 900 may regulate power consumption (block 960). In other words, by reducing the congestion threshold from the initial value to the modified value, the process 900 is able to mimic the congestion event, which regulates the power consumption of the network device. Power consumption of the network device may be a function of the data throughput of the network device. That is to say, when data throughput of the network device is reduced from an initial data throughput at the time of power surge event to a diminished data throughput because of the mimicked congestion event, the power consumption of the network device decreases and the network device recovers from the power surge event. The initial data throughput may reduce to the diminished data throughput based on an activation of a congestion management protocol (e.g., congestion notification, Explicit Congestion Notification “ECN” or the like) or a flow control protocol (e.g., priority-based flow control, employing pause frames or the like) on the network device due to the mimicked congestion event.

Although specific embodiments for dynamic regulation of power consumption in a network device are described above with respect to FIG. 9, any of a variety of systems and/or processes may be utilized in accordance with embodiments of the disclosure. In a still further embodiments, the process 900 may further pause non-essential operations, or reallocate resources for regulating power consumption based on a mimicked congestion event. The process 900 may function as a Power-o-Meter that monitors the one or more power usage metrics of the network device and as a Throttle-o-Meter that dynamically regulates the power consumption of the network device by leveraging the congestion management protocols or the flow control protocols enabled on the network device. The elements depicted in FIG. 9 may also be interchangeable with other elements of FIGS. 1-8 and 10-12 as required to realize a particularly desired embodiment.

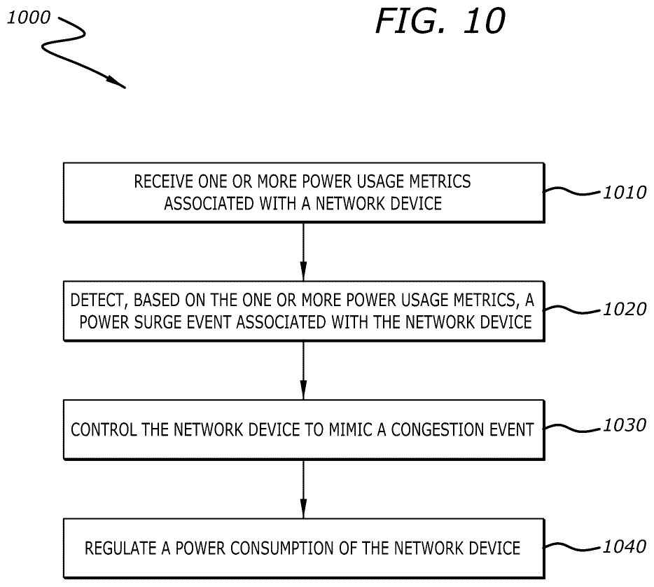

Referring to FIG. 10, a flowchart showing a process 1000 for remote regulation of power consumption of a network device in accordance with various embodiments of the disclosure is shown. The process 1000 may be performed at a standalone control device communicatively coupled to a plurality of network devices (e.g., spine switches, leaf switches or the like) in a network. In many embodiments, the process 1000 may receive one or more power usage metrics associated with a network device (block 1010). The one or more power usage metrics may include instantaneous power drawn, average power consumption over time, or peak power usage subjected to variations influenced by multiple factors, including but not limited to traffic rate, traffic pattern, atmospheric pressure, voltage, and temperature. The one or more power usage metrics may further include an average data byte size handled by the network device, an instantaneous total bandwidth utilized by the network device, or the like. The process 1000 may receive the one or more power usage metrics from a power-o-meter in the control device responsible for accurately collecting and maintaining real-time power usage metrics of the network devices in the network. The power-o-meter may refer to a data recorder, that continuously or periodically aggregates and updates cumulative power usage metrics from the network devices in the network. In numerous embodiments, the one or more power usage metrics may be received from the network device in real time or near real time. In numerous additional embodiments, the one or more power usage metrics may be received from the network device at a plurality of periodic time intervals.

In a variety of embodiments, the process 1000 may detect, based on the one or more power usage metrics, a power surge event associated with the network device (block 1020). In order to detect the power surge event, the process 1000 may compare at least one power usage metric (e.g., the power consumption) with a threshold value associated with the network device. The threshold value may be indicative of a maximum peak power setting or the maximum power usage limit of the network device. In more embodiments, the threshold value may be different for different network devices. In a scenario where the process 1000 determines, based on a result of the comparison, that the at least one power usage metric is greater than or equal to the threshold value, the process 1000 may detect the power surge event.

In a number of embodiments, the process 1000 may control the network device to mimic a congestion event (block 1030). To mimic the congestion event, the process 1000 may artificially simulate one or more conditions in the network device that may indicate an occurrence of the congestion event. For example, the process 1000 may transmit a control signal to the network device to reduce an initial value of a congestion threshold of a data queue in the network device to a modified value that is less than a current queue depth of the data queue. Since the modified value of the congestion threshold is less than the current queue depth of the data queue, the congestion event is mimicked.

In still further embodiments, the process 1000 may regulate a power consumption of the network device (block 1040). Based on the mimicked congestion event, a congestion management protocol or a flow control protocol enabled on the network device may get activated and result in the reduction of an initial data throughput at the time of the power surge to a diminished data throughput. In other words, slowing down of the data throughput rate may result in reduction in processing, handling and transmission speeds of the network device, which may further lead to decrease in the power consumption of the network device. Thus, the process 1000 may dynamically regulate the power consumption of the network device by mimicking the congestion event, ensuring that the network device operates within safe power limits.

Although a specific embodiment for remote dynamic regulation of power consumption of a network device suitable for carrying out the various steps, processes, methods, and operations described herein is discussed with respect to FIG. 10, any of a variety of systems and/or processes may be utilized in accordance with embodiments of the disclosure. For example, the process 1000 may perform predictive power consumption regulation of the network device even before the one or more power usage metrics exceed the threshold value. In still more embodiments, the process 1000 may provide protection against energy-based denial of service (DOS) attacks in the network based on the predictive power consumption regulation. For example, the energy-based DOS attacks may lead to power shutdown resulting in equipment downtime, equipment over or under cooling, or power corner cycling resulting in early hardware failure. Thus, by providing protection against energy-based DOS attacks, the process 1000 in turn mitigates the consequences (for examples, power shutdown resulting in equipment downtime, equipment over or under cooling, or power corner cycling resulting in early hardware failure) of the energy-based DOS attacks. The elements depicted in FIG. 10 may also be interchangeable with other elements of FIGS. 1-9, 11 and 12 as required to realize a particularly desired embodiment

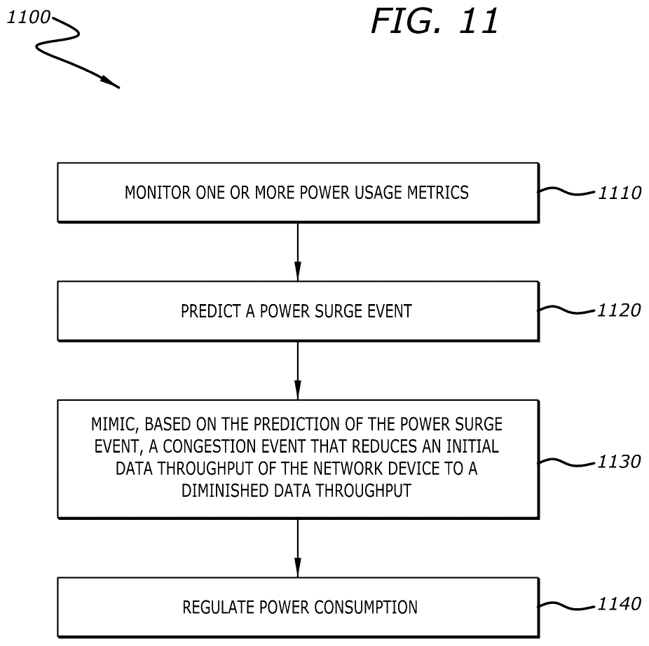

Referring to FIG. 11, a flowchart showing a process 1100 for pre-emptive regulation of power consumption of a network device in accordance with various embodiments of the disclosure is shown. The process 1100 may be performed at network device or a standalone control device communicatively coupled to the network device. In many embodiments, the process 1100 may monitor one or more power usage metrics (block 1110). For example, the monitored one or more power usage metrics of the network device may include energy consumption, voltage, and power drawn across a plurality of internal components of the network device. The monitored one or more power usage metrics of the network device may further include a running average data byte size, instantaneous total bandwidth consumption, or the like in the network device. In some embodiments, the process 1100 may continuously monitor the one or more power usage metrics of the network device as time-series data. In more embodiments, the process 1100 may monitor the one or more power usage metrics in real-time or near real-time.

In a variety of embodiments, the process 1100 may predict a power surge event (block 1120). In more embodiments, the process 1100 may utilize a machine learning or AI model to predict the power surge event. In an example embodiment, the machine learning or AI model may be trained based on a training dataset. The training dataset may include historical power usage metrics of a plurality of network devices collected before, during, and after past power surge events in the plurality of network devices. Further, the past power surge events may vary in their maximum peak power settings. By encompassing multiple peak power settings, the training dataset enables the machine learning/AI model to capture trends in power usage metrics under different threshold conditions. Once trained, the process 1100 may provide the monitored one or more power usage metrics and a maximum peak power setting of the network device as an input to the trained machine learning/AI model and the trained machine learning/AI model provides an output indicating a likelihood of an impending power surge event at a future time instance. Based on the output of the machine learning/AI model, the process 1100 may predict that the power surge event is likely to occur at the future time instance.

In a number of embodiments, the process 1100 may mimic, based on the prediction of the power surge event, a congestion event that reduces an initial data throughput of the network device to a diminished data throughput (block 1130). Once the power surge is predicted for the future time instance, the process 1100 may mimic the congestion event at the current time instance. For example, the process 1100 may artificially simulate one or more conditions in the network device that may indicate an occurrence of the congestion event. The process 1100 may reduce an initial value of a congestion threshold of a data queue in the network device to a modified value that is less than a current queue depth of the data queue. Based on the mimicked congestion event, a congestion management protocol or a flow control protocol enabled on the network device may get activated and result in the reduction of the initial data throughput to the diminished data throughput.

In numerous embodiments, the process 1100 may regulate power consumption (block 1140). That is to say, power consumption of the network device may be a function of the data throughput of the network device. Thus, as the data throughput increases, power consumption in the network device increases, whereas as the data throughput decreases, power consumption in the network device may also decrease. The process 1100 may leverage the congestion management protocol or the flow control protocol enabled on the network device to control data throughput of the network device, and in turn may regulate the power consumption of the network device in real time or in near real time. As the power consumption is regulated pre-emptively, the process 1100 may prevent the occurrence of the power surge event. Such pre-emptive regulation of the power consumption may provide protection against energy-based denial of service attacks, in which malicious entity forces the network device to perform excessive or resource-intensive tasks consuming very high power.

Although a specific embodiment for pre-emptive regulation of power consumption of a network device suitable for carrying out the various steps, processes, methods, and operations described herein is discussed with respect to FIG. 11, any of a variety of systems and/or processes may be utilized in accordance with embodiments of the disclosure. As one of ordinary skill in the art will readily recognize, the examples and technologies provided above are simply for clarity and explanation purposes and can include many additional concepts and variations. For example, the process 1100 may introduce artificial delays in processing packets or fill data queues with dummy packets to create the illusion of a full buffer. This forces the network device to treat it as a congestion event. In another example, the process 1100 may limit the outgoing or incoming data rate to simulate reduced bandwidth availability, giving the impression of network congestion. In yet another example, the process 1100 may intentionally drop or delay packets at predetermined thresholds, causing backpressure in upstream devices and triggering congestion control mechanisms. Further, the process 1100 may use protocols such as priority flow control or pause frames to halt packet transmission temporarily, mimicking network congestion. The process 1100 may also set ECN bits in the data packet headers to signal network devices to slow down their transmission, simulating a congestion state without actually overwhelming buffers. In still other examples, the process 1100 may inject high volumes of traffic into specific interfaces or queues, creating a spike in load that resembles a congestion event. Further, the process 1100 may utilize one or more fine and coarse-grained traffic engineering techniques to control data flow effectively. The process 1100 may further perform deep packet inspection (DPI). The DPI may involve analyzing and classifying the series of data packets based on corresponding data types, sampling, filtering, and grouping the series of data packets as needed. Based on the classification of the series of data packets, the process 1100 may prioritize or manage the initial data throughput according to specific energy/power or operational requirements. The elements depicted in FIG. 11 may also be interchangeable with other elements of FIGS. 1-10 and 12 as required to realize a particularly desired embodiment.

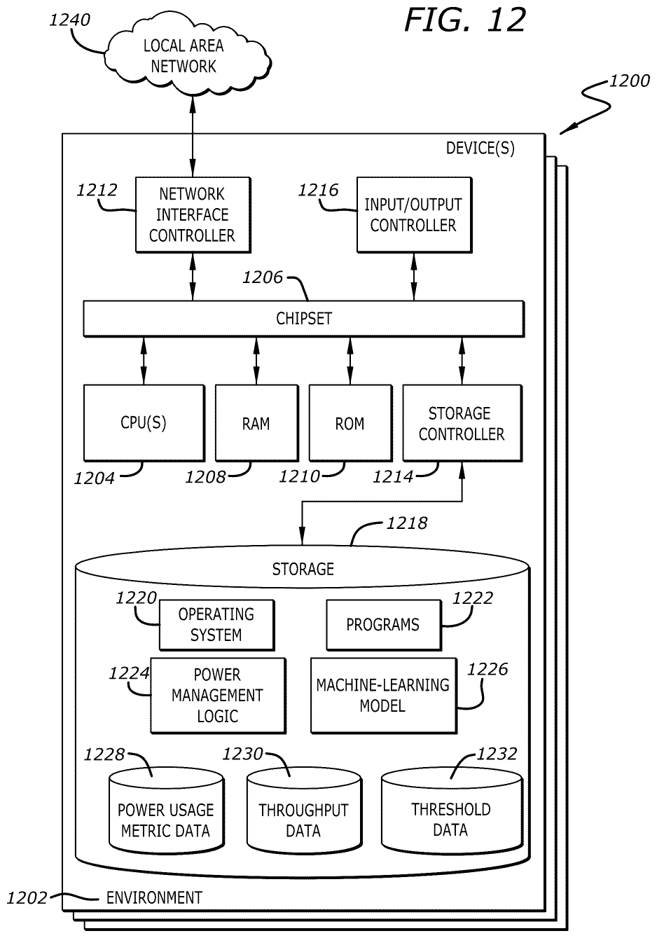

Referring to FIG. 12, a conceptual block diagram of a device 1200 suitable for configuration with a power management logic, in accordance with various embodiments of the disclosure is shown. The embodiment of the conceptual block diagram depicted in FIG. 12 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 12 can also illustrate an access point, a switch, or a router in accordance with various embodiments of the disclosure. The device 1200 may, in many nonlimiting examples, correspond to physical devices or to virtual resources described herein.

In many embodiments, the device 1200 may include an environment 1202 such as a baseboard or “motherboard,” in physical embodiments that can be configured as a printed circuit board with a multitude of components or devices connected by way of a system bus or other electrical communication paths. Conceptually, in virtualized embodiments, the environment 1202 may be a virtual environment that encompasses and executes the remaining components and resources of the device 1200. In more embodiments, one or more processors 1204, such as, but not limited to, central processing units (“CPUs”) can be configured to operate in conjunction with a chipset 1206. The processor(s) 1204 can be standard programmable CPUs that perform arithmetic and logical operations necessary for the operation of the device 1200.

In a number of embodiments, the processor(s) 1204 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1206 may provide an interface between the processor(s) 1204 and the remainder of the components and devices within the environment 1202. The chipset 1206 can provide an interface to a random-access memory (“RAM”) 1208, which can be used as the main memory in the device 1200 in some embodiments. The chipset 1206 can further be configured to provide an interface to a computer-readable storage medium such as a read-only memory (“ROM”) 1210 or non-volatile RAM (“NVRAM”) for storing basic routines that can help with various tasks such as, but not limited to, starting up the device 1200 and/or transferring information between the various components and devices. The ROM 1210 or NVRAM can also store other application components necessary for the operation of the device 1200 in accordance with various embodiments described herein.

Additional embodiments of the device 1200 can be configured to operate in a networked environment using logical connections to remote computing devices and computer systems through a network, such as the network 1240. The chipset 1206 can include functionality for providing network connectivity through a network interface card (“NIC”) 1212, which may comprise a gigabit Ethernet adapter or similar component. The NIC 1212 can be capable of connecting the device 1200 to other devices over the network 1240. It is contemplated that multiple NICs 1212 may be present in the device 1200, connecting the device to other types of networks and remote systems.

In further embodiments, the device 1200 can be connected to a storage 1218 that provides non-volatile storage for data accessible by the device 1200. The storage 1218 can, for instance, store an operating system 1220, programs 1222, power usage metric data 1228, throughput data 1230, and threshold data 1232 which are described in greater detail below. The storage 1218 can be connected to the environment 1202 through a storage controller 1214 connected to the chipset 1206. In certain embodiments, the storage 1218 can consist of one or more physical storage units. The storage controller 1214 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1200 can store data within the storage 1218 by transforming the physical state of the physical storage units to reflect the information being stored. The specific transformation of physical state can depend on various factors. Examples of such factors can include, but are not limited to, the technology used to implement the physical storage units, whether the storage 1218 is characterized as primary or secondary storage, and the like.

In many more embodiments, the device 1200 can store information within the storage 1218 by issuing instructions through the storage controller 1214 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1200 can further read or access information from the storage 1218 by detecting the physical states or characteristics of one or more particular locations within the physical storage units.

In addition to the storage 1218 described above, the device 1200 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1200. In some examples, the operations performed by a cloud computing network, and or any components included therein, may be supported by one or more devices similar to device 1200. Stated otherwise, some or all of the operations performed by the cloud computing network, and or any components included therein, may be performed by one or more devices 1200 operating in a cloud-based arrangement. By way of example, and not limitation, computer-readable storage media can include volatile and non-volatile, removable and non-removable media implemented in any method or technology.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1218 can store an operating system 1220 utilized to control the operation of the device 1200. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1218 can store other system or application programs and data utilized by the device 1200.

In many additional embodiments, the storage 1218 or other computer-readable storage media is encoded with computer-executable instructions which, when loaded into the device 1200, may transform it from a general-purpose computing system into a special-purpose computer capable of implementing the embodiments described herein. These computer executable instructions may be stored as programs 1222 (e.g., an application) and transform the device 1200 by specifying how the processor(s) 1204 can transition between states, as described above. In some embodiments, the device 1200 has access to computer-readable storage media storing computer executable instructions which, when executed by the device 1200, perform the various processes described above with regard to FIGS. 1-12. In certain embodiments, the device 1200 can also include computer-readable storage media having instructions stored thereupon for performing any of the other computer-implemented operations described herein.

In still further embodiments, the device 1200 can also include one or more input/output controllers 1216 for receiving and processing input from a number of input devices, such as a keyboard, a mouse, a touchpad, a touch screen, an electronic stylus, or other type of input device. Similarly, an input/output controller 1216 can be configured to provide output to a display, such as a computer monitor, a flat panel display, a digital projector, a printer, or other type of output device. Those skilled in the art will recognize that the device 1200 might not include all of the components shown in FIG. 12 and can include other components that are not explicitly shown in FIG. 12 or might utilize an architecture completely different than that shown in FIG. 12.

As described above, the device 1200 may support a virtualization layer, such as one or more virtual resources executing on the device 1200. In some examples, the virtualization layer may be supported by a hypervisor that provides one or more virtual machines running on the device 1200 to perform functions described herein. The virtualization layer may generally support a virtual resource that performs at least a portion of the techniques described herein.

In many further embodiments, the device 1200 may include a power management logic 1224. The power management logic 1224 can be configured to perform one or more of the various steps, processes, operations, and/or other methods that are described above. Often, the power management logic 1224 can be a set of instructions stored within a non-volatile memory that, when executed by the processor(s)/controller(s) 1204 can carry out these steps, etc. In numerous embodiments, the power management logic 1224 may perform various operations related to dynamic power consumption regulation of network devices. In such embodiments, the power management logic 1224 may be to monitor one or more power usage metrics associated with power consumed by a network device (e.g., the device 1200 or any other network device) in the network. In more embodiments, the power management logic 1224 may be configured to compare at least one power usage metric with a threshold value indicative of a maximum peak power setting of the network device. In a scenario where the power management logic 1224 determines, based on a result of the comparison, that the at least one power usage metric is greater than or equal to the threshold value, the power management logic 1224 may detect a power surge event.

Based on the detection of the power surge event, the power management logic 1224 may be configured to mimic a congestion event that reduces an initial data throughput of the network device to a diminished data throughput. In still further embodiments, the power management logic 1224 may regulate the power consumption based on the reduction of the initial data throughput of the network device to the diminished data throughput. Reduction in data throughput may lead to decrease in power consumption in the network device and thus, the network device may operate within safe power limits without disruption in data transmission events.

In various embodiments, the storage 1218 can include the power usage metric data 1228. The power usage metric data 1228 may refer to key indicators that help monitor and assess the power consumption of the network device, such as instantaneous power (real-time usage), average power (consumption over a period), and peak power (maximum usage during a timeframe). The power usage metric data 1228 may also include energy usage (total energy consumed over time), power factor (efficiency of power use), idle power (baseline consumption when the device is not active), and dynamic power (power usage that fluctuates with network traffic or workload). The power usage metric data 1228 may further indicate running average data byte size, instantaneous total bandwidth, or the like of the network device.

In still more embodiments, the storage 1218 can include the throughput data 1230. The throughput data 1230 may include key metrics that measure the performance and capacity of a network, such as the rate of data transmission (in bits per second or bytes per second), packet loss (percentage of data packets lost during transmission), latency (time delay between sending and receiving data), jitter (variations in latency), and bandwidth utilization (the percentage of available capacity being used). The throughput data 1230 may also include peak and average throughput, error rates, retransmissions, and congestion levels of the network device.

In a number of embodiments, the storage 1218 can include threshold data 1232. The threshold data 1232 may refer to predefined limits used to manage network performance and power consumption. One type of threshold data 1232 may define the maximum peak power setting, ensuring that the network device operates within safe power limits by capping the maximum power consumption. Another threshold data 1232 may be associated with queue fill levels or congestion thresholds, which determine the maximum capacity a data queue can handle before triggering congestion or flow control mechanisms.

Finally, in numerous additional embodiments, data may be processed into a format usable by a machine-learning model 1226 (e.g., feature vectors), and or other preprocessing techniques. The machine-learning (“ML”) model 1226 may be any type of ML model, such as supervised models, reinforcement models, and/or unsupervised models. The ML model 1226 may include one or more of linear regression models, logistic regression models, decision trees, Naïve Bayes models, neural networks, k-means cluster models, random forest models, and/or other types of ML models 1226.

The ML model(s) 1226 can be configured to generate inferences to make predictions or draw conclusions from data. An inference can be considered the output of a process of applying a model to new data. This can occur by learning from at least the power usage metric data 1228, the throughput data 1230, and the threshold data 1232, and utilize the learning to predict future outcomes. For example, the ML model(s) 1226 can be used for predicting a power surge event and triggering a congestion event by artificially forcing the one or more data queues to appear as full. This may be done by using supervised learning techniques like linear regression or random forests can forecast sustainability scores using historical data, such as power consumption or network traffic. Unsupervised learning methods, such as k-means clustering, can detect hidden patterns in network behavior and resource usage. To train the ML model, a detailed dataset such as the power usage metric data 1228, the throughput data 1230 and the threshold data 1232 can be gathered. Preprocessing and feature extraction may be performed to identify the most important data points. This refined data is used to train the ML/AI model, allowing it to learn relevant patterns.

Once trained, the ML model 1226 may be integrated into the device 1200 to make real-time decisions or predictions based on the dynamic power consumption regulation in network devices such that the network devices always operate within safe power limits that does not lead to data transmission disruption or shutdown a data center. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1226 may be generated by human/administrator verifications or may compare predicted outcomes with actual outcomes.

Although a specific embodiment for a device suitable for configuration with a power management logic for carrying out the various steps, processes, methods, and operations described herein is discussed with respect to FIG. 12, any of a variety of systems and/or processes may be utilized in accordance with embodiments of the disclosure. For example, the device may be in a virtual environment such as a cloud-based network administration suite, or it may be distributed across a variety of network devices or switches. The elements depicted in FIG. 12 may also be interchangeable with other elements of FIGS. 1-11 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A network device, comprising:
a processor;
a network controller configured to provide access to a network; and
a memory communicatively coupled to the processor, wherein the memory comprises a power management logic that is configured to:
detect a power surge event associated with the network device; and
mimic, based on the detection of the power surge event, a congestion event for the network device that reduces an initial data throughput of the network device at a time of the power surge event to a diminished data throughput.

2. The network device of claim 1, wherein a power consumption of the network device decreases based on the reduction of the initial data throughput to the diminished data throughput.

3. The network device of claim 2, wherein based on the decrease in the power consumption, the network device recovers from the power surge event.

4. The network device of claim 1, wherein the power management logic is further configured to regulate power consumption in the network device based on the mimicked congestion event.

5. The network device of claim 1, wherein to detect the power surge event, the power management logic is further configured to monitor one or more power usage metrics associated with the network device.

6. The network device of claim 5, wherein at least one power usage metric of the one or more power usage metrics corresponds to a power consumption by the network device.

7. The network device of claim 6, wherein the power management logic is further configured to:
compare the at least one power usage metric with a threshold value associated with the network device; and
determine, based on a result of the comparison, that the at least one power usage metric is greater than or equal to the threshold value, wherein the power surge event is detected in response to determining that the at least one power usage metric is greater than or equal to the threshold value.

8. The network device of claim 5, wherein the one or more power usage metrics comprise one or more of an average data byte size handled by the network device or an instantaneous total bandwidth utilized by the network device.

9. The network device of claim 5, wherein the power management logic is further configured to monitor the one or more power usage metrics in real time or near real time.

10. The network device of claim 5, wherein the power management logic is further configured to monitor the one or more power usage metrics at a plurality of periodic time intervals.

11. The network device of claim 1, wherein the power management logic is further configured to mimic the congestion event based on at least one of a congestion management protocol or a flow control protocol enabled on the network device.

12. The network device of claim 1, wherein the network device is associated with one or more data queues, and to mimic the congestion event, the power management logic is further configured to reduce a congestion threshold associated with at least one data queue of the one or more data queues from an initial value to a modified value.

13. The network device of claim 12, wherein the power management logic is further configured to obtain the modified value based on a current queue depth of the at least one data queue at a time of the power surge event.

14. The network device of claim 13, wherein the modified value is less than the current queue depth of the at least one data queue.

15. A control device, comprising:
a processor;
a network interface controller configured to provide access to a network, wherein the network comprises one or more network devices; and
a memory communicatively coupled to the processor, wherein the memory comprises a power management logic that is configured to:
detect a power surge event associated with a network device of the one or more network devices; and
control the network device to mimic a congestion event, wherein the mimicked congestion event reduces an initial data throughput of the network device at a time of the power surge event to a diminished data throughput.

16. The control device of claim 15, wherein the power management logic is further configured to receive one or more power usage metrics associated with the network device.

17. The control device of claim 16, wherein the power management logic is further configured to:
compare at least one power usage metric of the one or more power usage metrics with a threshold value associated with the network device; and
determine, based on a result of the comparison, that the at least one power usage metric is greater than or equal to the threshold value, wherein the power surge event is detected in response to determining that the at least one power usage metric is greater than or equal to the threshold value.

18. The control device of claim 16, wherein the one or more power usage metrics are received from the network device in real time or near real time.

19. The control device of claim 16, wherein the one or more power usage metrics are received from the network device at a plurality of periodic time intervals.

20. A method, comprising:
detecting a power surge event associated with a network device; and
mimicking, based on the detection of the power surge event, a congestion event for the network device that causes a reduction in an initial data throughput of the network device at a time of the power surge event to a diminished data throughput.
